(19) United States
(12) Patent Application Publication
(10) Pub. No.: US 2024/0034657 A1
(43) Pub. Date: Feb. 1, 2024

(54) TREATMENT OF AQUEOUS SYSTEMS

(71) Applicant: MFG CHEMICAL, LLC, Chattanooga, TN (US)

(72) Inventor: Michael Lee Standish, Chattanooga, TN (US)

(73) Assignee: MFG CHEMICAL, LLC, Chattanooga, TN (US)

(21) Appl. No.: 18/373,217

(22) Filed: Sep. 26, 2023

Related U.S. Application Data
(63) Continuation-in-part of application No. 17/743,603, filed on May 13, 2022.
Application No. 17/743,603 is a continuation of application No. 15/937,990, filed on Mar. 28, 2018, now Pat. No. 11,358,891.
Application No. 15/937,990 is a division of application No. 14/525,216, filed on Oct. 28, 2014, now abandoned.

(51) Int. Cl. C02F 5/10; C08F 222/02; C08F 222/04

(52) U.S. Cl. CPC C02F 5/10; C08F 222/02; C08F 222/04; C02F 2101/10

(57) ABSTRACT

A method is described for selecting a treatment additive for aqueous systems, in which crystal habit modification properties are prioritized; for aqueously preparing a substantially polymaleic additive through in-situ formation of maleic acid copolymer so that mono-carboxylic acids, non-ionic functional groups, and terminal hydroxyl groups are also formed during polymerization; and for applying such additives for treatment of aqueous systems. Treatment agents resulting from these processes are also described.

### CROSS-REFERENCE TO RELATED APPLICATION

The present application claims priority to and is a continuation-in-part of U.S. patent application Ser. No. 17/743,603, filed May 13, 2022, which is a continuation of U.S. patent application Ser. No. 15/937,990, filed Mar. 28, 2018, which is a divisional application of U.S. patent application Ser. No. 14/525,216, filed Oct. 28, 2014, all of which are incorporated herein by reference in their entireties.

### FIELD

The present disclosure relates generally to treatment of aqueous systems and more specifically to treatment of aqueous systems with substantially maleic copolymers.

### BACKGROUND

The present invention relates to treating aqueous systems to prevent or remediate problems of mineral scale deposition and buildup. Fields of expected application include, without limitation, water treatment, industrial aqueous systems treatment, cooling water systems, boiler operation, thermal and reverse osmosis desalination activities, gas and oilfield operations, municipal and wastewater treatment, pulp and paper processes, and detergent/cleaning applications.

Various types of contaminants in an aqueous system under a variety of conditions can cause problems such as corrosion, microbiological contamination, or mineral scaling, in which contaminants precipitate out of solution in the system and form undesirable scale deposits on system surfaces. Of particular interest to the present invention is the challenge of scale management. Polymer mediated scale control techniques historically involve a variety of mechanisms that are generally known in the art, including, for example, threshold inhibition, sequestration, chelation, stabilization, particulate dispersion, and crystal habit modification. These mechanisms are discussed and defined below.

Threshold inhibition involves extending the solubility of an otherwise insoluble salt beyond normal saturation limits using an additive which functions at sub-stoichiometric levels. This sub-stoichiometric functionality differentiates treatment additives such as polymers and phosphonates from materials that function according to strict stoichiometric ratios such as Ethylenediaminetetraacetic acid (EDTA). Threshold inhibition is often a temporary effect. For example, if uninhibited water takes 60 seconds to begin precipitating calcium carbonate in a given set of conditions (such as pH, temperature, concentrations of calcium and carbonate, etc.), the same water may be treated to extend this time to one hour through a threshold inhibition additive. The extent and duration of threshold inhibition may be related to a variety of factors or conditions, including without limitation the driving forces for precipitation (pH, temperature, concentrations of scale-forming ions, etc.), the particular efficacy of a selected threshold inhibition additive, other water impurities (dissolved or suspended), rate of water concentration or evaporation, and frequency of additive dosage.

Sequestration can be another important function of treatment additives, particularly of many polymers and phosphonates. Sequestration is the complexation of a metal ion such that the ion does not retain its original reactive properties. Unlike threshold inhibition, sequestration does not connote either stoichiometry or specific functionality. Some phosphonate or polymer additives commonly used for mineral scale control can sequester ions such as calcium, magnesium, and barium, preventing them from forming insoluble complexes with compounds such as carbonate and sulfate.

A chelate is a coordination compound in which a central metal ion such as Ca²⁺ is attached by coordinate links to two or more non-metal atoms in the same molecule, called ligands. Thus, a chelating agent is an additive that links to a metal ion at two or more points within the agent molecule. In practice, polymers such as polycarboxylates and sulfonated copolymers act as chelating agents with most multi-valent ions due to the multiple binding sites along the polymer's backbone. In common usage, chelation further implies a more permanent or substantive relationship between the ion and the ligand and refers to stoichiometric relationships between the metal ion and the ligand.

Stabilization may refer to two distinct mechanisms. In colloidal stabilization, precipitation in a fluid (such as water) occurs, but the polymer additive prevents agglomeration of particles larger than one micron in size. These particles are thus stabilized via electrostatic interactions with the polymer and remain suspended throughout the water phase. These sub-micron particles are typically invisible to the naked eye. A notable exception to this is stabilized iron particles, which can be visible due to the orange-brown color associated with most oxidized (Fe³⁺) iron complexes. Colloidal stabilization can fail due to physical or chemical changes in the fluid that result in particulate agglomeration beyond one micron in size and bulk settling of the precipitate. The alternate usage of “stabilization” is as a synonym for sequestration, where a coordination complex between a polymer additive and soluble ions, or surface interaction between polymer and forming crystal lattices, occurs, preventing precipitation.

Particulate dispersion is a suspension of particulates in an aqueous solution. Particulate dispersion involves a mixture of finely divided particles, called the internal phase (often of colloidal size), being distributed in a continuous medium, called the external phase. These can be inorganic (e.g., calcium carbonate), organic (e.g., biomass), or a mixture of the two. Polymer composition and molecular weight (Mw) are key determinants in deriving functionality for effective particulate dispersion.

The final mechanism discussed here in relation to scale control is crystal habit modification. A crystal habit is defined as the normal size and shape of a precipitated substance in a given set of environmental conditions. FIGS. 1A through 1E illustrate simplistically a formation process of crystals such as calcium carbonate, and the crystals' subsequent deposition onto surfaces. The formation of crystals such as calcium carbonate and their subsequent deposition onto surfaces follow a process, simplified here for clarity, of nucleation (illustrated in FIG. 1A), lattice formation and propagation (illustrated in FIG. 1B), bulk precipitation (illustrated in FIG. 1C), and surface deposition (illustrated in FIGS. 1D & 1E). Modification of crystal habit involves introducing a “poison” or contaminating additive that disrupts normal lattice formation. This, in turn, yields crystals tending either to re-dissolve or to precipitate in abnormal forms that deviate from the substance's untreated crystal habit. This effect tends to reduce cohesion of the crystals to each other (dispersion) and adhesion of crystals to system surfaces (scaling).

Although the general mechanisms described above are known and, to some degree, understood in the art of treating aqueous systems, the exact functionality of treatment additives often is not. In practice, various polymer additives often are viewed as single-purpose. In application, threshold inhibition is often prioritized as the most important scale control mechanism, to the relative neglect of other mechanisms. By focusing more precisely on additive functionalities, it is possible to take advantage of interrelationships among these scale control mechanisms, and improvements can be achieved in the art of treating aqueous systems.

An object of the invention is to achieve improved treatment of aqueous systems by re-prioritizing the scale treatment mechanisms targeted. A further object is to prepare a substantially poly-maleic additive through in-situ formation of maleic acid copolymer so that mono-carboxylic acids, non-ionic functional groups, and terminal hydroxyl groups are also formed during polymerization. Improved treatments may then be applied to aqueous systems to achieve various improvements in scale prevention or remediation.

The discussion of shortcomings and needs existing in the field prior to the present disclosure is in no way an admission that such shortcomings and needs were recognized by those skilled in the art prior to the present disclosure.

### SUMMARY

Various embodiments solve the above-mentioned problems and provide methods and devices useful for

In a basic embodiment of the invention, a method is described to prioritize crystal habit modification in selecting a treatment additive for aqueous systems. In further illustrative embodiments, polymer materials are specified which exhibit improved crystal habit modification properties and other advantages. Also, methods are specified for preparing and applying improved polymer additives to prevent, reduce, or remediate scale formation or precipitation in aqueous systems.

These and other features, aspects, and advantages of various embodiments will become better understood with reference to the following description, figures, and claims.

### BRIEF DESCRIPTION OF THE DRAWINGS

Many aspects of this disclosure can be better understood with reference to the following figures.

FIG. 1A depicts nucleation (diffusion from solution to solids). FIG. 1B illustrates lattice formation and propagation (disorder to order). FIG. 1C depicts macro calcite formation, bulk precipitation, and exhaustion of soluble ions. FIG. 1D illustrates surface deposition via adhesion to a metal surface. FIG. 1E illustrates surface deposition via adhesion to a tube/pipe interior.

FIG. 2A illustrates a typical understanding of mechanisms of polymer functionality. FIG. 2B depicts an improved understanding which prioritizes crystal habit modification as a first-order concern in treating aqueous systems.

FIG. 3A conceptually depicts sequestration and chelation in polymer interactions with divalent calcium in an illustrative case. FIG. 3B conceptually depicts sequestration, chelation, crystalloid formation, and stabilization.

FIG. 4A is a conceptual depiction of polymer adsorption onto a forming crystal lattice.

FIG. 4B further illustrates dimensions of inhibited crystal growth. FIG. 4C depicts re-dissolution of an unstable crystal lattice. FIG. 4D shows bulk precipitation with crystal habit modification of the bulk precipitate.

FIG. 5A illustrates crystal habit modification in bulk precipitates relative to surfaces in a system. FIG. 5B illustrates crystal habit modification in bulk precipitates relative to surfaces in a system.

FIG. 6 is a table of simplified polymer functionalities for some common mineral scales and deposits.

FIG. 7A illustrates polymer rigidity under stressed water conditions for an enhanced copolymer according to an embodiment of the invention. FIG. 7B illustrates polymer rigidity under stressed water conditions for mono-carboxylic acid polymers such as polyacrylic acid.

FIG. 8 is a table detailing experimental conditions.

FIG. 9A illustrates compound microscopy showing exclusive formation of calcite in a blank sample without polymer treatment at 10× magnification. FIG. 9B illustrates compound microscopy showing exclusive formation of calcite in a blank sample without polymer treatment at 40×.

FIG. 10A illustrates a Scanning Electron Micrograph (SEM) showing a uniform calcite (cubic calcium carbonate) precipitate at 250× magnification. FIG. 10B illustrates a Scanning Electron Micrograph (SEM) showing a uniform calcite (cubic calcium carbonate) precipitate at 1500×.

FIG. 11A illustrates compound microscopy of results of PMA treatment at 15 mg/l at 40× magnification. FIG. 11B illustrates SEM micrograph results of PMA treatment at 15 mg/l at 1500× magnification. FIG. 11C illustrates compound microscopy results of PMA treatment at 30 mg/l at 40× magnification. FIG. 11D illustrates SEM micrograph results of PMA treatment at 30 mg/l at 1500× magnification.

FIG. 12A illustrates compound microscopy results of MOP treatment at 15 mg/l at 40× magnification. FIG. 12B illustrates SEM micrograph results of MOP treatment at 15 mg/l at 1500× magnification. FIG. 12C illustrates compound microscopy results of MOP treatment at 30 mg/l at 40× magnification. FIG. 12D illustrates SEM micrograph results of MOP treatment at 30 mg/l at 1800× magnification.

FIG. 13A illustrates compound microscopy results of treatment at 15 mg/l using an enhanced copolymer at 40× magnification. FIG. 13B illustrates SEM micrograph results of treatment at 15 mg/l using an enhanced copolymer at 1500× magnification. FIG. 13C illustrates compound microscopy results of treatment at 30 mg/l using an enhanced copolymer at 40× magnification. FIG. 13D illustrates SEM micrograph results of treatment at 30 mg/l using an enhanced copolymer at 1500× magnification.

FIG. 14 is a chart comparing threshold inhibition performance between PMA and an enhanced copolymer under severe calcium test conditions.

FIG. 15 is a nuclear magnetic resonance (NMR) spectrograph of a prior art material, as copied from U.S. Pat. No. 5,135,677 (Yamaguchi et al).

FIG. 16 is an NMR spectrograph of an enhanced copolymer.

FIG. 17 shows chemical structures and reactions related to an enhanced copolymer.

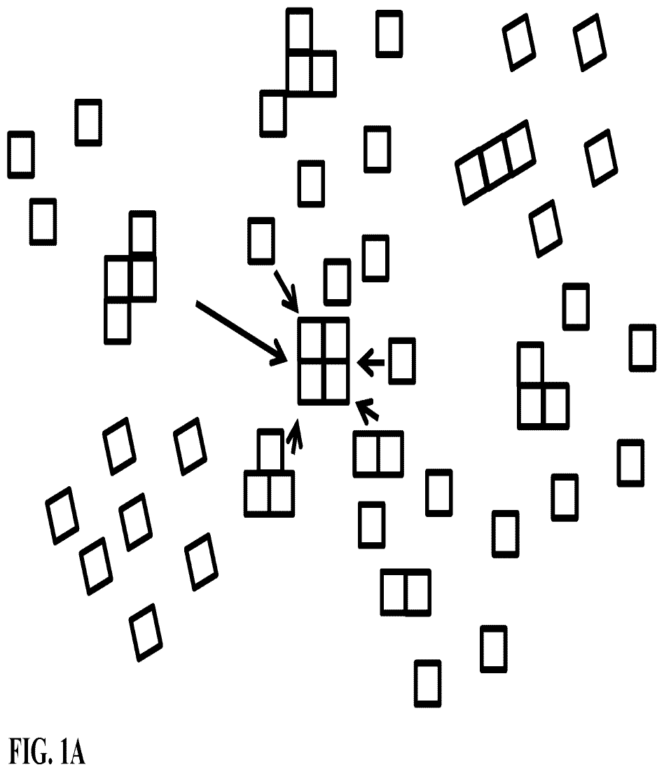

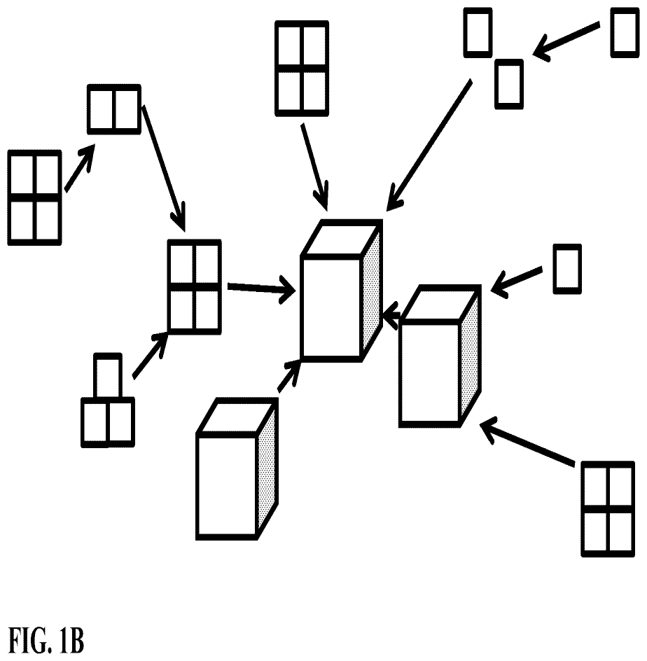

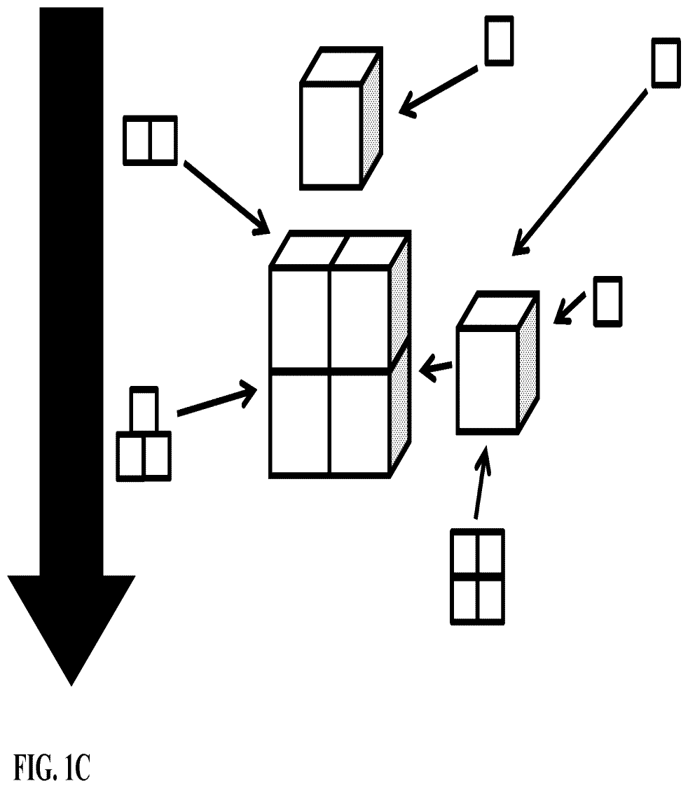

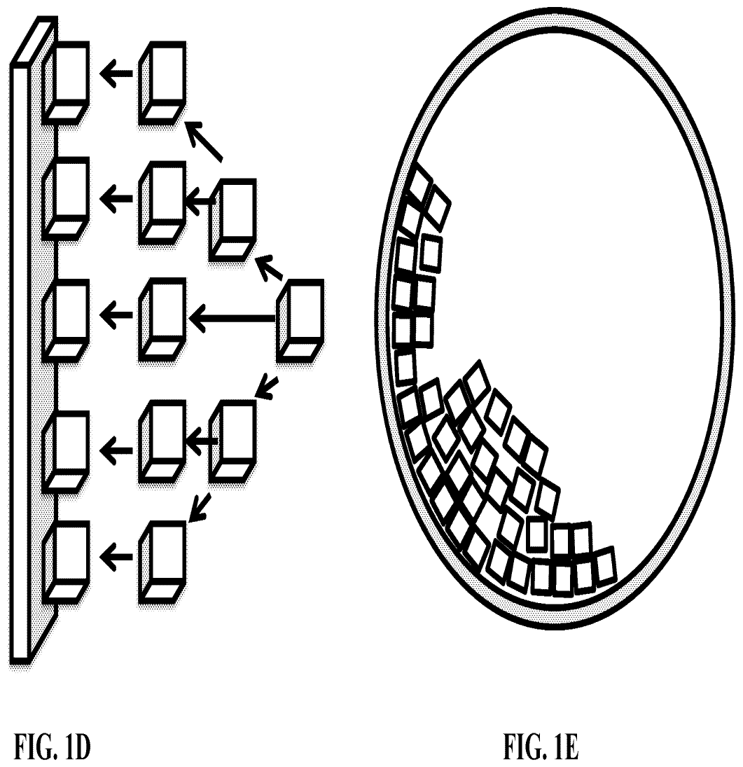

It should be understood that the various embodiments are not limited to the examples illustrated in the figures.

### DETAILED DESCRIPTION

### Introduction and Definitions

This disclosure is written to describe the invention to a person having ordinary skill in the art, who will understand that this disclosure is not limited to the specific examples or embodiments described. The examples and embodiments are single instances of the invention which will make a much larger scope apparent to the person having ordinary skill in the art. Unless defined otherwise, all technical and scientific terms used herein have the same meaning as commonly understood by the person having ordinary skill in the art. It is also to be understood that the terminology used herein is for the purpose of describing examples and embodiments only, and is not intended to be limiting, since the scope of the present disclosure will be limited only by the appended claims.

All the features disclosed in this specification (including any accompanying claims, abstract, and drawings) may be replaced by alternative features serving the same, equivalent, or similar purpose, unless expressly stated otherwise. Thus, unless expressly stated otherwise, each feature disclosed is one example only of a generic series of equivalent or similar features. The examples and embodiments described herein are for illustrative purposes only and that various modifications or changes in light thereof will be suggested to the person having ordinary skill in the art and are to be included within the spirit and purview of this application. Many variations and modifications may be made to the embodiments of the disclosure without departing substantially from the spirit and principles of the disclosure. All such modifications and variations are intended to be included herein within the scope of this disclosure. For example, unless otherwise indicated, the present disclosure is not limited to particular materials, reagents, reaction materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

All numeric values are herein assumed to be modified by the term “about,” whether or not explicitly indicated. The term “about” generally refers to a range of numbers that one of skill in the art would consider equivalent to the recited value (for example, having the same function or result). In many instances, the term “about” may include numbers that are rounded to the nearest significant figure.

In everyday usage, indefinite articles (like “a” or “an”) precede countable nouns and noncountable nouns almost never take indefinite articles. It must be noted, therefore, that, as used in this specification and in the claims that follow, the singular forms “a,” “an,” and “the” include plural referents unless the context clearly dictates otherwise. Thus, for example, reference to “a support” includes a plurality of supports. Particularly when a single countable noun is listed as an element in a claim, this specification will generally use a phrase such as “a single.” For example, “a single support.”

Unless otherwise specified, all percentages indicating the amount of a component in a composition represent a percent by weight of the component based on the total weight of the composition. The term “mol percent” or “mole percent” generally refers to the percentage that the moles of a particular component are of the total moles that are in a mixture. The sum of the mole fractions for each component in a solution is equal to 1.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

In this specification and in the claims that follow, reference will be made to a number of terms that shall be defined to have the following meanings unless a contrary intention is apparent.

“Standard temperature and pressure” generally refers to 25° C. and 1 atmosphere. Standard temperature and pressure may also be referred to as “ambient conditions.” Unless indicated otherwise, parts are by weight, temperature is in ° C., and pressure is at or near atmospheric. The terms “elevated temperatures” or “high-temperatures” generally refer to temperatures of at least 100° C.

“Mixing” refers to a unit operation in industrial process engineering that involves manipulation of a heterogeneous physical system with the intent to make it more homogeneous. Mixing is performed to allow heat and/or mass transfer to occur between one or more streams, components, or phases.

Known methods and additives have tended to emphasize threshold inhibition as a primary mechanism in treating aqueous systems. Illustrative embodiments of the invention prioritize effective crystal habit modification in the selection, preparation, and application of treatment additives.

Crystal growth is dynamic. Crystalloids (forming crystal lattices) that do not grow properly tend to re-dissolve. Treatment additives, as discussed above, can modify the size and shape of mineral crystal habits. Crystal habit modification is a significant basis for improved treatment of aqueous systems. In fact, crystal habit modification itself can yield improved performance in other scale control mechanisms. Crystal modification is a mechanism that facilitates the sub-stoichiometric action of threshold inhibition. Crystal modification is also an in-situ mechanism that prevents or reduces particle cohesion, resulting in reduced deposition tendency. Crystal modification additionally produces distortions in crystalline surface or lattice structure that limit surface-to-surface contact area, thus limiting potential adhesion. Further, what is recognized as stabilization and, in some cases, dispersion, can also be enabled or enhanced by the functionality of crystal habit modification. Thus, through better understanding of how polymer additives act to modify crystal habit, enhanced additive performance across several scale control mechanisms can be realized, yielding enhanced overall performance.

When designing or selecting a polymer for mineral scale control, it is important to recognize the desired primary functionalities, their impact upon scale control efficacy, and nuances that may enhance overall performance. Polymers can be particularly sensitive to a wide range of design factors, including for example composition, molecular weight, molecular weight distribution, polymer end-groups, and the manufacturing or polymerization process utilized. Each of these considerations can have substantial consequences upon overall performance, the emphasized functional feature (e.g., threshold inhibitor, dispersant, crystal modifier), the polymer's stability and retained performance in severe service conditions, and the type of mineral scale or deposit the polymer will control.

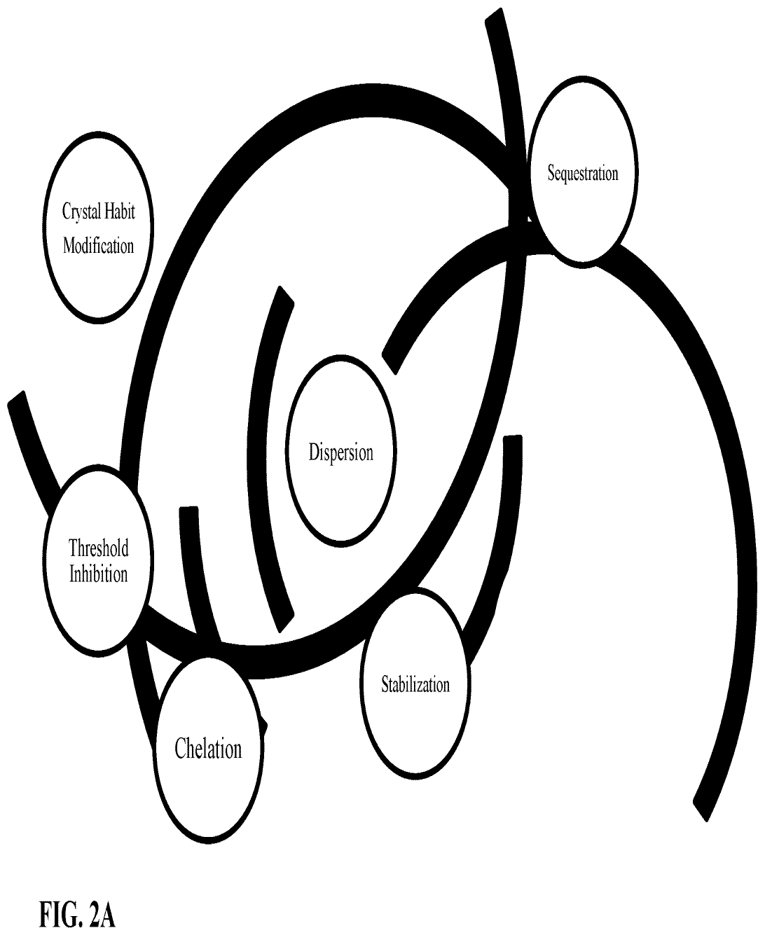

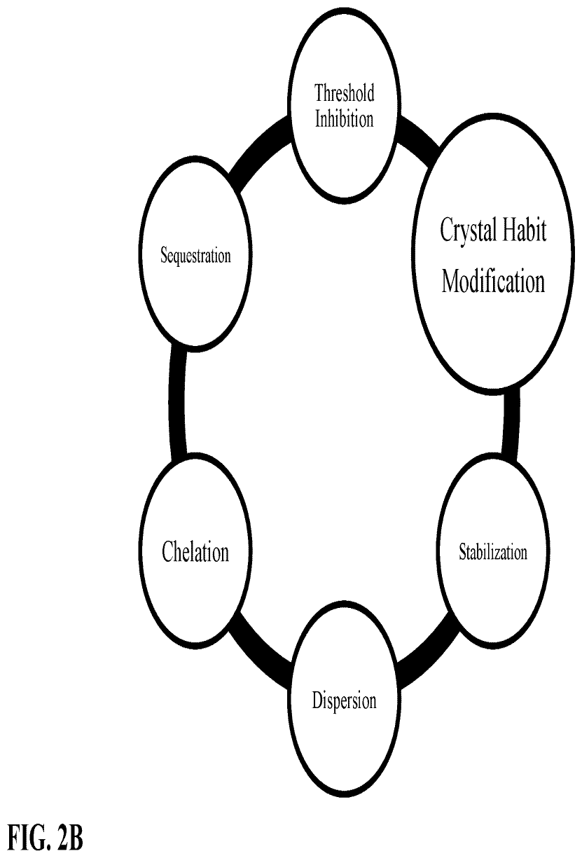

In an embodiment of the invention, crystal habit modification is prioritized as a primary functionality of potential polymer additives for treating aqueous systems. FIG. 2A illustrates a typical view of polymer functionality, in which each of the six scale control mechanisms described above are viewed discretely, and one or more mechanisms may be selected as a primary treatment focus. While it may be common for some producers or sellers of treatment additives to make broad claims for a product's functionality across most or all of these mechanisms, a skeptical purchaser or user of such products often has come to view each one as a single-purpose additive. Thus the interrelationships of functional mechanisms for polymer additives may be easily overestimated or underestimated. FIG. 2B depicts a re-alignment of focus on these functional mechanisms, prioritizing crystal habit modification as a first-order concern in treating aqueous systems.

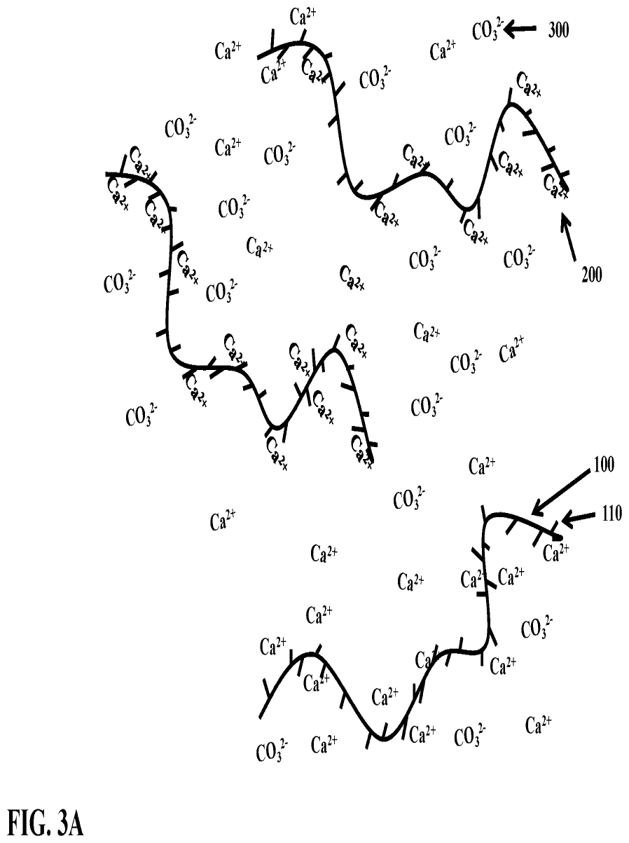

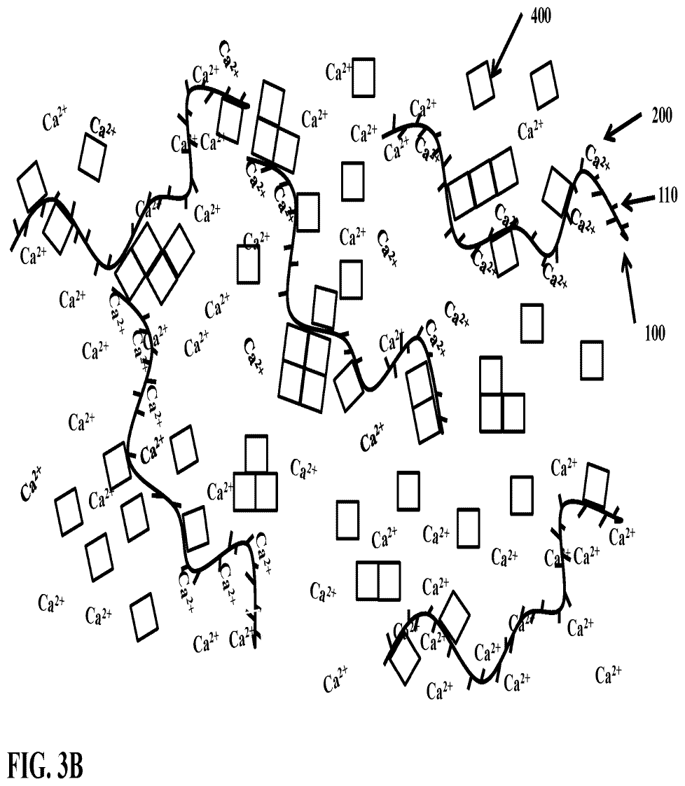

As illustrated in FIG. 2B, the mechanisms enabling polymer additive functionalities are to a large degree interconnected. Overall scale control can be better achieved by employing multiple mechanisms sequentially or simultaneously. To illustrate this, using for example a carboxylated homopolymer such as polymaleic acid to control calcium carbonate scaling, all six scale control functionalities are likely relevant to the scale management process. Sequestration could be an initial interaction employed between the polymaleic acid and calcium carbonate. As illustrated in FIG. 3A, in the sequestration line of defense, the polymer 100 is sequestering calcium ions 200 such that the calcium ions 200 are unavailable for combination with carbonate ions 300. By definition, chelation is also employed here. The carboxylic acid (H—O—C═O or COOH) functional groups 110 along the backbone of polymer 100 carry a minus one charge. Because of this, two carboxylic acid groups 110 are required to fully sequester each divalent (2+) calcium ion 200. It is this coordination of the polymer 100 at two sites along the molecule with the calcium ion (central metal ion) 200 that meets the formal definition of chelation.

The functionality of sequestration and chelation by such polymers is typically temporary in process water treatment applications such as cooling towers and boilers. The duration (how long?) and extent (how much?) the polymer can maintain solubility of calcium in an environment where carbonate species is present is dependent upon many factors, including the concentration of the scale forming ions (in this case [Ca²⁺][CO₃²⁻]), pH, temperature, polymer concentration, polymer efficacy (design), presence and concentration of suspended solids, presence and concentration of other soluble ions, the rate in which the water (and its impurities) are concentrated, and the frequency of polymer addition.

FIG. 3B illustrates that as calcium carbonate 400 begins to precipitate in this example, it is necessary for the polymer 100 to interact with both the soluble calcium 200 that remains in solution (sequestration, chelation) and also the forming crystal lattices 400, which are sometimes referred to as crystalloids. These calcium carbonate crystalloids 400 can be thought of as “pre-crystals” as they have begun to form crystal lattices that are necessary for formation of macro, insoluble calcium carbonate scale. However, these crystalloids 400 are considered soluble or, at least, at the verge of precipitation and highly vulnerable to re-solubilization. In this case, the polymer 100 can begin to exhibit stabilization functionality. The polymer 100 may not be able to fully sequester all the calcium ions 200 that are present, nor may it be able to prevent formation or repeated dissolution (partial threshold inhibition mechanism) of crystalloids 400, but it may be effective in preventing growth of the crystalloids beyond the size of colloidal particles.

A key determinant in the functionality of threshold inhibition is a sub-stoichiometric relationship between the level of polymer and the scale forming species. A strict mechanism of sequestration and/or chelation would not allow for this relationship. Rather, a process of partial and/or temporary sequestration, formation of the crystalloid, and re-dissolution of the interrupted crystal lattice formation is necessary to accomplish this phenomenon at sub-stoichiometric ratios. With reference again to FIG. 3B, through the process it can be envisioned that the polymer 100 is fighting a battle on two fronts: the water soluble battle with divalent calcium 200 and the water insoluble battle against calcium carbonate crystalloids 400. As it has been defined, threshold inhibition is a temporary effect. Thus, the polymer 100 can be understood to be winning and losing each of these battles simultaneously until bulk precipitation occurs. The polymer 100 essentially wins as it sequesters divalent calcium ions 200 (water soluble battle) and as it adsorbs onto crystalloid surfaces 400 (water insoluble battle) disrupting crystal lattice formation. The effective concentration of polymer 100 is constantly being depleted as the polymer wages war on both fronts. However, as crystalloids 400 re-dissolve, the polymer 100 too is freed to continue the battle on the water soluble front with calcium ions 200. This process is continued up to the point at which crystalloids 400 tend to form lattices 500 that do not re-dissolve, where larger macro-structures of calcium carbonate form, and bulk precipitation occurs. Again, the rate and duration of this polymer-calcium carbonate war is dependent upon a variety of factors, including several previously mentioned. Threshold inhibition is an unusual event that is somewhat specific to certain polymers and phosphonates. Other materials that can have much stronger sequestering or chelating properties or a much higher affinity for adsorption onto forming calcium carbonate do not exhibit threshold inhibition properties.

Once bulk precipitation has occurred, the two remaining mechanisms for mineral scale control may be employed. Dispersion is perhaps the simpler of the two, although nuances exist here. It is important to separate the concept into two pieces: in-situ dispersion and post-precipitation dispersion. In both cases, the polymer is effective in maintaining a suspension (dispersion) in solution by electrostatic repulsion. In each case, the polymer interacts both with the precipitate and with other polymer molecules to prevent agglomeration and resultant separation from solution. However, in some cases, where the polymer is present in-situ, another benefit can be employed. If the polymer is effective in modifying or distorting crystals as precipitation occurs, those crystals are much less likely to cohere to other crystals and thus are much more easily dispersed. Polymaleic acid is a known example of this in-situ mechanism. Polymaleic acid is actually rather poor at suspending solids due to its very low molecular weight (typically 500-800 Daltons). In contrast, polymaleic acid is rather effective at preventing agglomeration of solids such as calcium carbonate when it is present as a crystal habit modifier during the precipitation process.

The ability of a polymer to modify the crystal habit of mineral scales is known in the art. Folklore suggests that prior to the invention of synthetic polymers for this purpose, starch (a naturally occurring polymer) from potatoes was utilized to soften scale in the boilers of steam locomotive engines. More recently, synthetic polymers such as polycarboxylates (polyacrylic acids, polymaleic acids), sulfonated copolymers, and various other polymers have been used specifically for this purpose in a variety of water treatment applications. The concept of crystal habit modification is simple and qualitative. Essentially, the expectation for the polymer is to adsorb onto the surface of a forming crystal lattice, impede the directional growth of the lattice, and subsequently promote the formation of precipitated crystals that are abnormal in shape, size, and overall appearance.

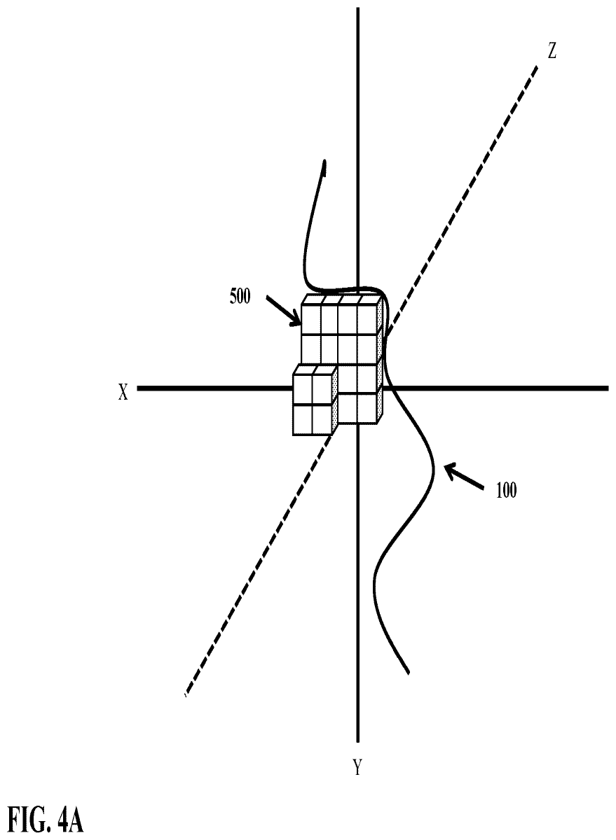

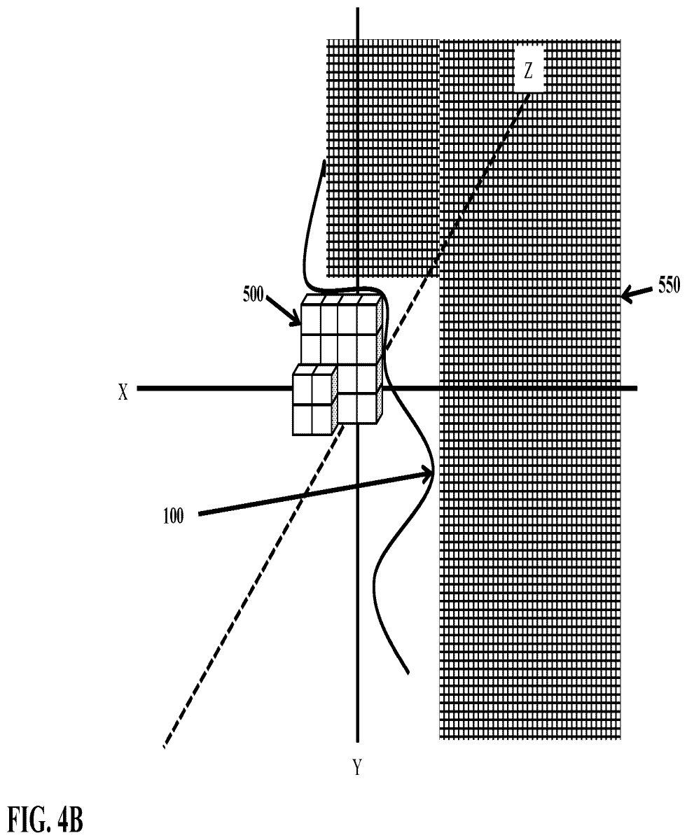

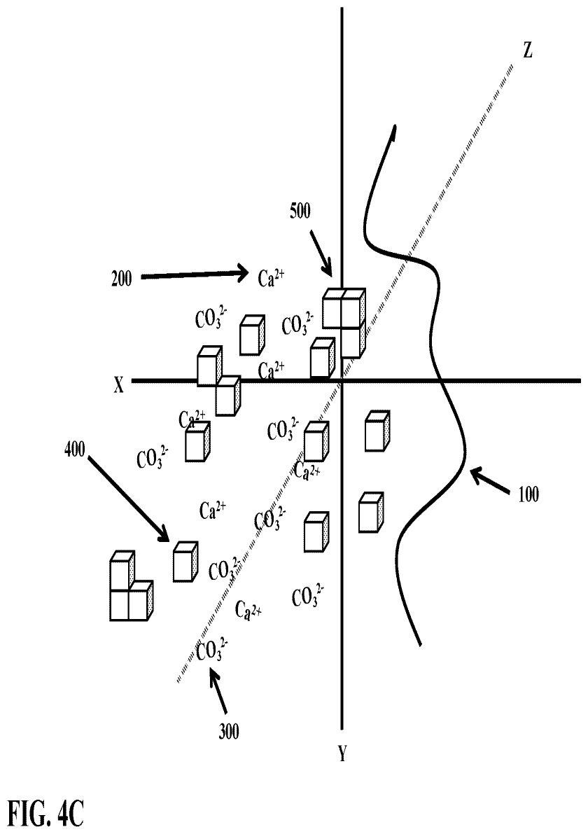

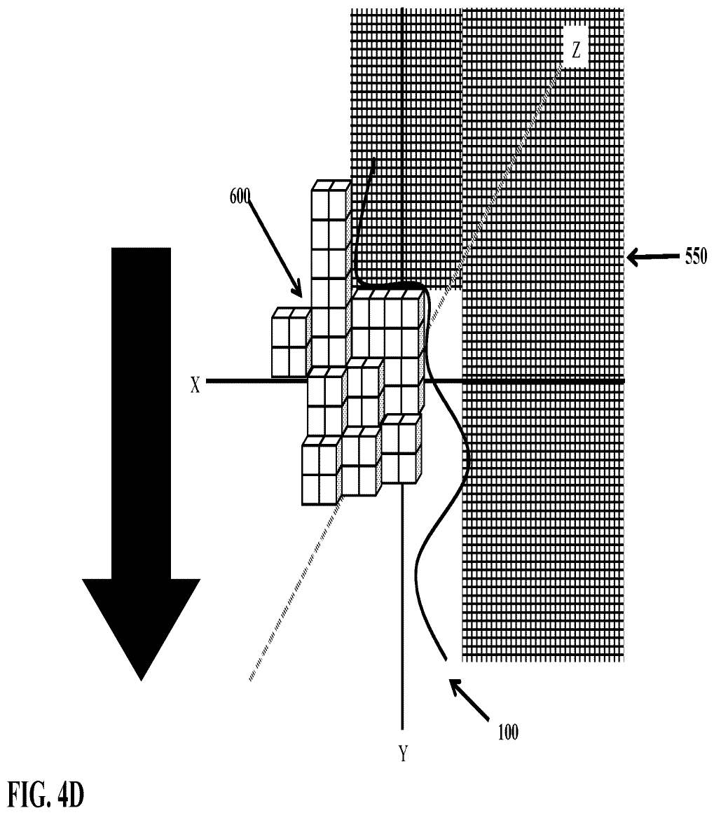

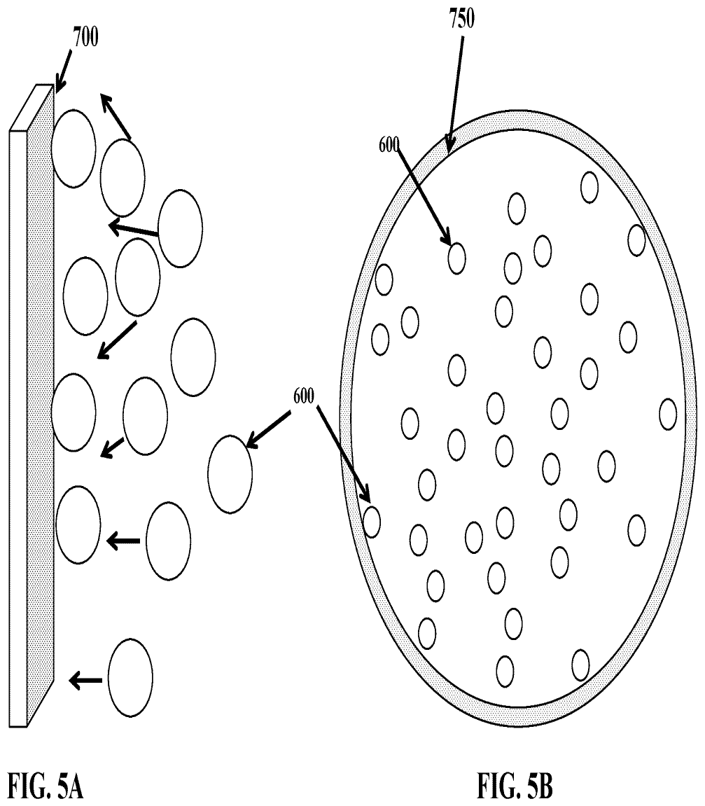

This can be illustrated in FIGS. 4A-4D. FIG. 4A shows a three-dimensional illustration of a forming crystal lattice 500 where a polymer 100 begins to adsorb onto the lattice surface. It can be observed in FIG. 4B how this adsorption of the polymer 100 inhibits directional growth of the forming crystal lattice 500 in several dimensions or directions 550. The directional growth inhibition then leads to one of two events with the forming crystal lattice 500. The lattice 500 is either unstable, such that it tends to re-dissolve (FIG. 4C) as crystalloids 400, or bulk precipitation occurs and crystal habit modification of the bulk precipitate 600 is observed (FIG. 4D). FIGS. 5A-5B illustrate the benefit of crystal habit modification in the bulk precipitate 600, which now exhibits fewer planar crystal surfaces with lower overall planar surface area. The effect is improved scale management performance, even as precipitate 600 potentially interacts with, e.g., a metal surface 700 or a tube or pipe interior 750.

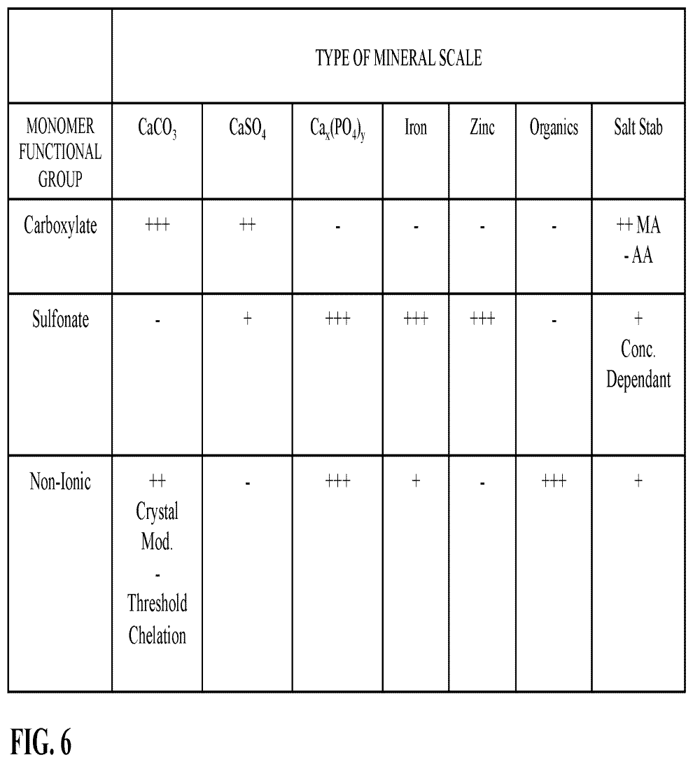

When designing a polymer for mineral scale control, it is important to recognize the desired primary functionalities, their impact upon efficacy, and nuances that might enhance overall performance. Polymers can be particularly sensitive to a wide range of design factors. Among these are considerations such as composition, molecular weight, molecular weight distribution, polymer end groups, and the manufacturing or polymerization process utilized. Each of these considerations can have substantial consequences upon overall performance, the emphasized functional feature (threshold inhibitor, dispersant, crystal modifier, etc.), the polymer's stability or retained performance in severe service conditions, and the type of mineral scale or deposit the polymer will control. Some insights as to how composition relates to functionality are provided in the table FIG. 6, where it can be observed that a carboxylate group, such as from acrylic acid and maleic acid, can provide the basis of functionality for calcium carbonate and calcium sulfate. Further, sulfonate groups can provide functionality for calcium phosphate, iron, and zinc stabilization. Non-ionic groups are typically utilized to enhance polymer performance by increasing interaction with a particular surface. Examples of this include the addition of a non-ionic to enhance calcium carbonate crystal modification properties, improve calcium phosphate and iron stabilization, or to add a viable interface to organics or biomass. The implications of molecular weight can be oversimplified to generalize that lower molecular weight (<3,000 Daltons) polymers tend to provide better threshold inhibition properties, while polymers with an average molecular weight between 5,000 and 10,000 Daltons tend to function better as stabilizers and particulate dispersants. Of course there are exceptions to these rules of thumb but they largely hold true throughout the range of polymers commonly offered to industry. Other aspects such as the polymerization process, end-group selection, and molecular weight distribution can have a tremendous impact upon polymer performance as well. One good example of this is the use of hypophosphite in the preparation of polyacrylates. These polymers are known as phosphinocarboxylates but, more accurately, they are polyacrylates prepared using sodium hypophosphite. These polymers are known to have better thermal stability and tolerance to iron and salts than typical polyacrylates prepared by more conventional methods.

Thus, an embodiment of the invention prioritizes effective crystal habit modification in the selection, preparation, and application of treatment additives. Focusing on effective crystal habit modification yields corollary benefits in other mechanisms of functionality, and can provide better overall scale management performance than prioritizing threshold inhibition or other mechanisms.

In further embodiments, improved copolymer additives are specified to achieve improved crystal habit modification performance, and corollary benefits.

The use of polymaleic acid (PMA) for calcium carbonate scale control has been known for many years, since approximately the 1920's. German, British, and American scientists seemingly recognized the potential efficacy and commercial benefits of PMA in similar time periods. Widespread industrial use of PMA began in the 1970's and continues in the present. PMA is known, accepted, and utilized for the treatment of water and, in particular, the control of calcium carbonate. Further, PMA has become a leading choice for service companies seeking an effective additive for severe service applications in cooling waters, boilers, oilfield operations, large-scale thermal desalination activities, and various other uses.

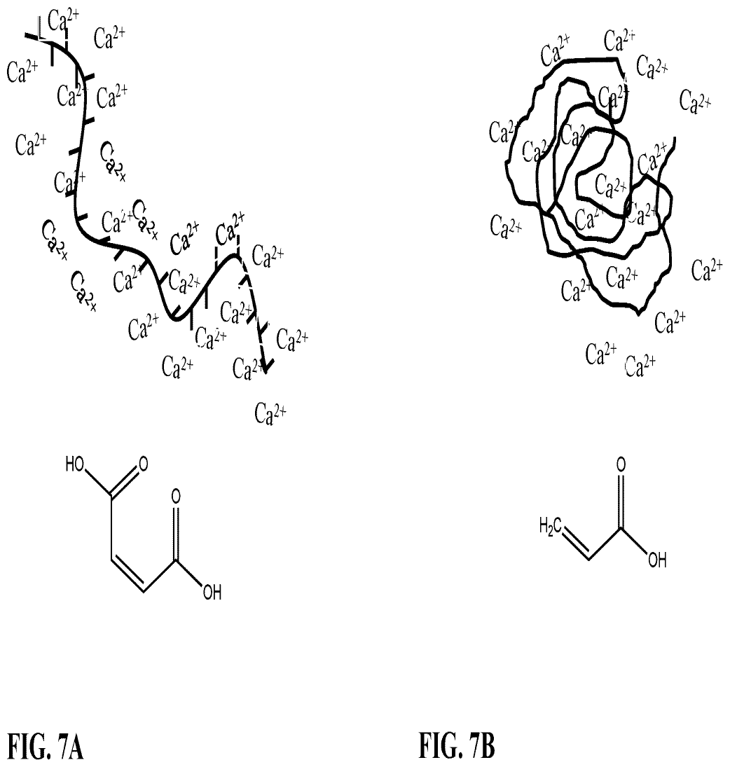

In an embodiment of the invention, improved copolymers with certain similarities to PMA exhibit improved performance in several aspects, as compared to PMA and also to mono-carboxylic acid polymers such as polyacrylic acid. For example, improved copolymers according to the invention can exhibit improved stability in harsh water conditions, improved crystal habit modification performance for calcite (a cubic form of calcium carbonate), and highly effective calcium carbonate threshold inhibition in harsh waters. In contrast to mono-carboxylic polymers such as polyacrylic acid, the stability of such improved copolymers in harsh water systems is enhanced due to the presence and proximity of di-carboxylic acid groups along the copolymer backbone. The negative charge inherent within each carboxylic acid functional group provides effective repulsion along the backbone of the copolymer. This electrostatic repulsion, in turn, provides rigidity and stability along the copolymer that reduces the incidence of it coiling or collapsing upon itself as it encounters high levels of hardness or salinity in an aqueous environment. This comparison is illustrated in FIGS. 7A-7B. The continued extension of the copolymer conformation in harsh water environments (FIG. 7A) provides that the copolymer not only remains stable (soluble) in such conditions, but also retains its functional properties. This is in contrast to polymers such as polyacrylic acid (in FIG. 7B), which can lose both solution stability and efficacy in comparable environments.

Modification of calcium carbonate crystals is of increasing importance in modern water treatment applications. Beyond providing an underlying mechanism that enables threshold inhibition, as described above, crystal modification itself can be a primary functionality controlling mineral scale deposition in failure situations. Industry initiatives such as water conservation, use and reuse of poorer quality make-up water, and elimination of phosphorous tend to increase the likelihood of bulk precipitation and the ultimate formation of deposited mineral scale. Enhanced copolymers according to the invention can exhibit markedly improved crystal modification properties for calcite, compared to known industry products such as PMA and Multifunctional One Polymers (MOP).

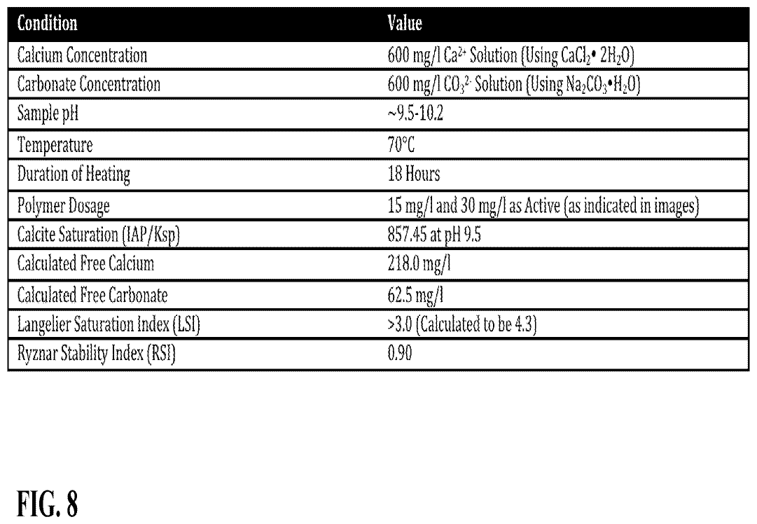

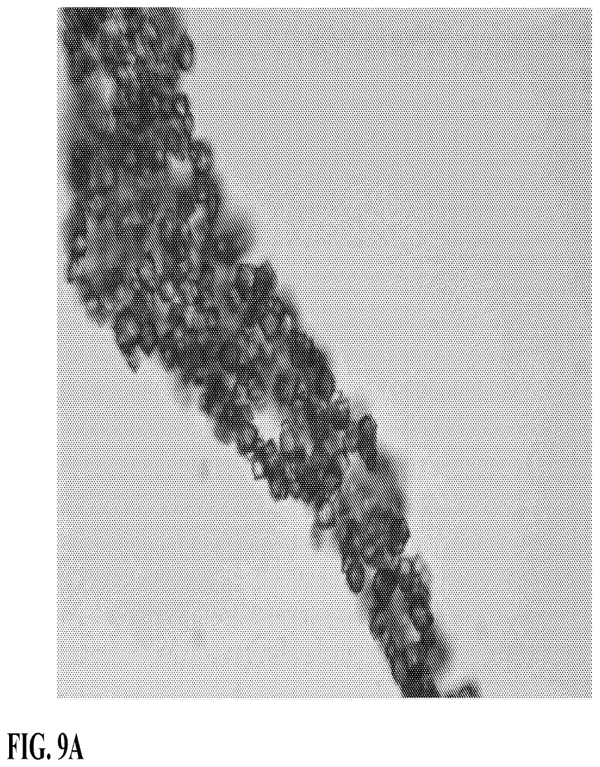

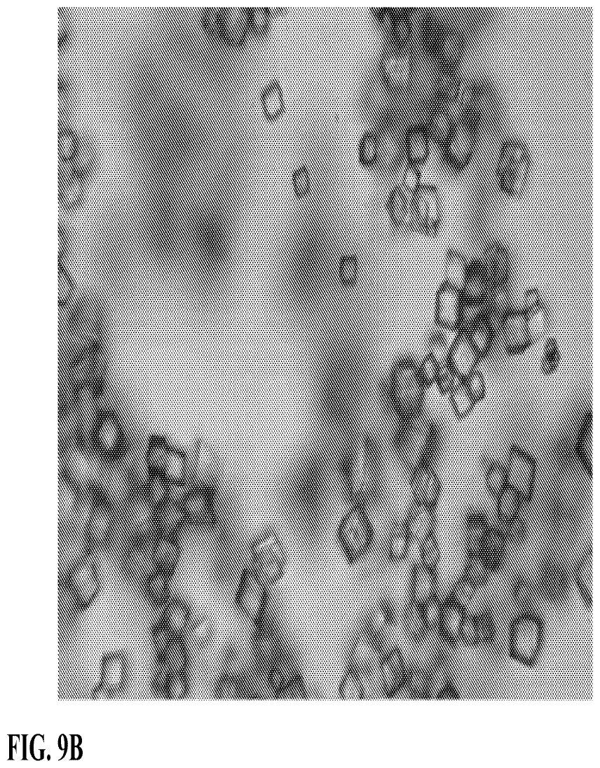

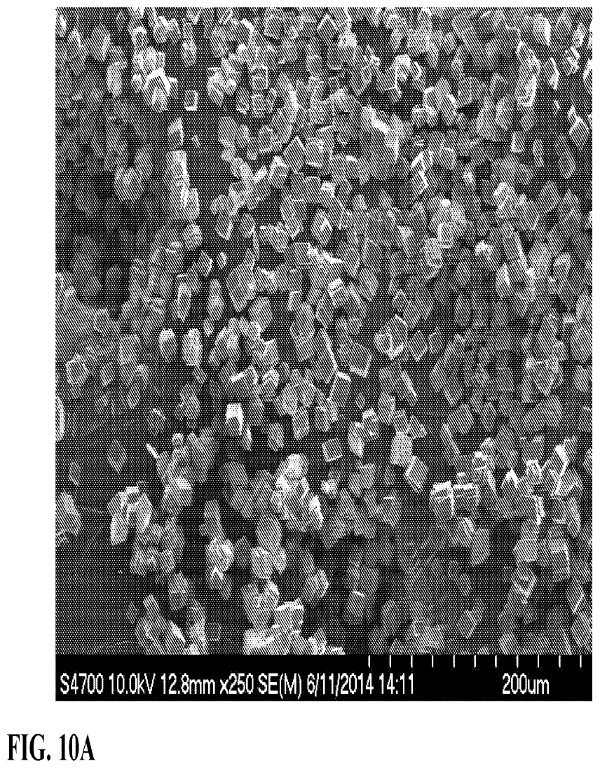

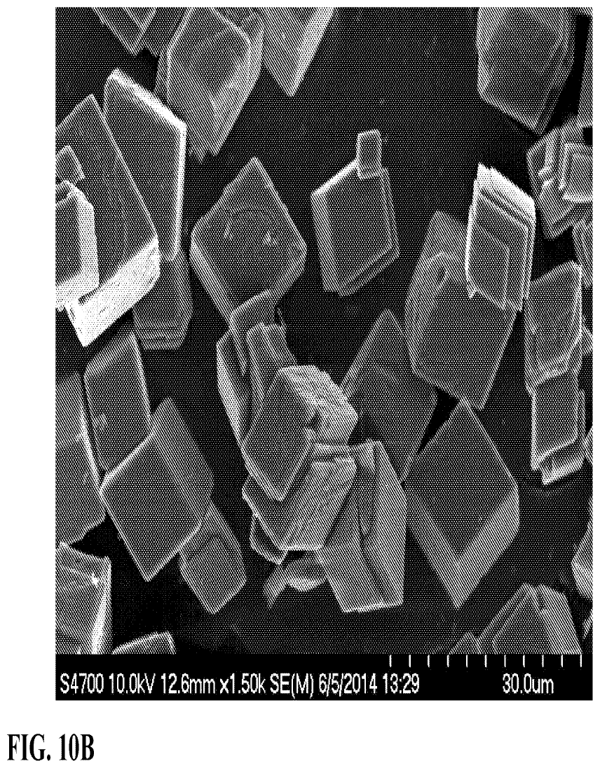

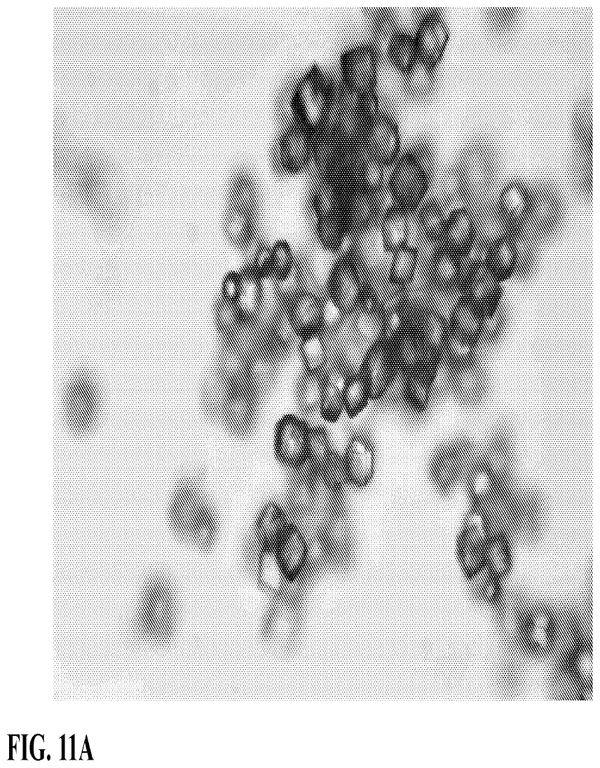

Experimental observation and testing can demonstrate the effects of polymers as crystal habit modifiers. For example, experimental observations to evaluate relative crystal modification properties of PMA, MOP polymers, and enhanced copolymers according to the invention show improvements achieved at 15 mg/l and 30 mg/l treatment dosages relative to a blank sample with no polymer treatment. Since PMA, MOP, and enhanced copolymers each can be effective threshold inhibitors in severe conditions, laboratory work was performed under conditions that would ensure precipitation occurred, and crystal modification properties could be observed. 50 ml of a solution containing 1200 mg/l of Ca²⁺ (using CaCl₂y·2H₂O) was treated with the designated polymer dosage. Using Na₂CO₃·H₂O, 50 ml of a 1200 mg/l solution of CO₃²⁻ was then added to the Ca²⁺, polymer-dosed solution. Additional solutions contained 600 mg/l of Ca²⁺ and 600 mg/l of CO₃²⁻. Each solution was measured to have a pH of 9.5 to 10.2 and was heated in a water bath at 70° C. for 18 hours. The samples were allowed to cool and the precipitate was collected using a plastic transfer pipette, and samples were examined by both compound and Scanning Electron Microscopy (SEM) using a Hitachi S-4700 Type II cold field emission SEM. The table depicted in FIG. 8 details the severe service conditions of the experiments. The exclusive formation of calcite is represented in FIGS. 9A-9B for the blank (no polymer treatment). Similarly, the SEM micrographs represented in FIGS. 10A-10B reveal that experimental conditions produced a uniform calcite (cubic calcium carbonate) precipitate.

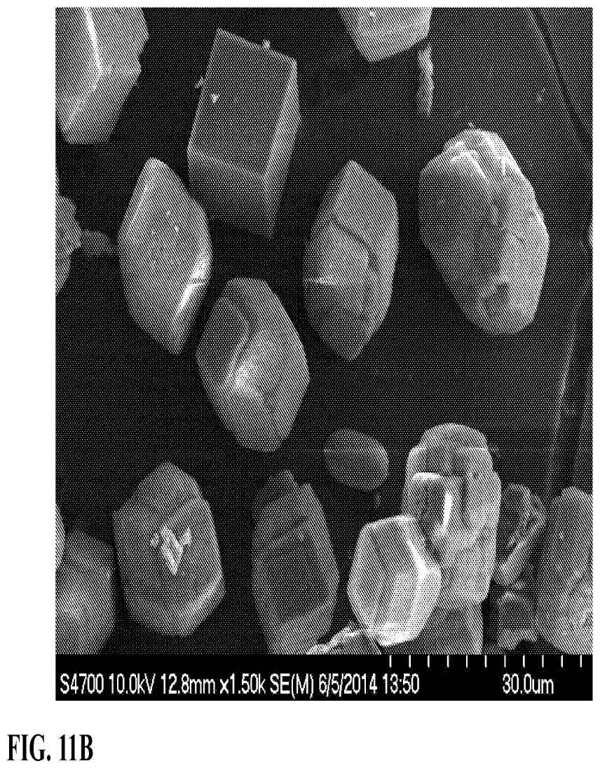

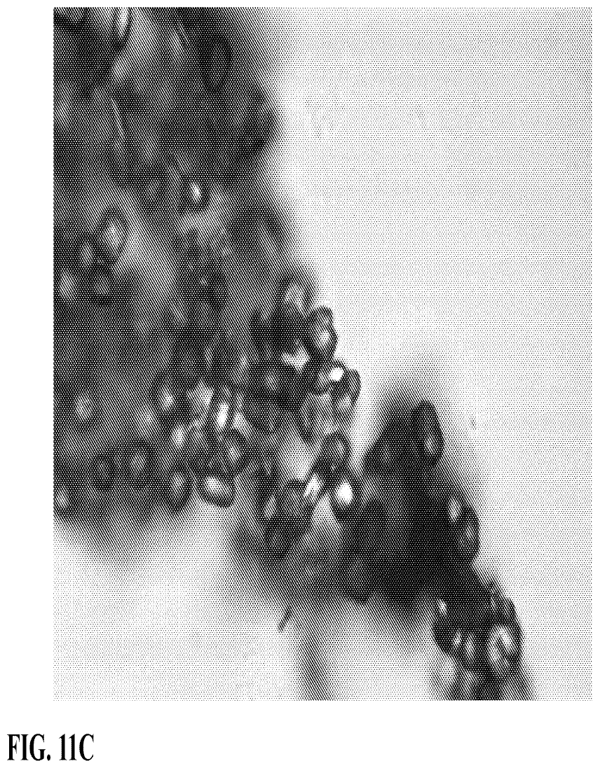

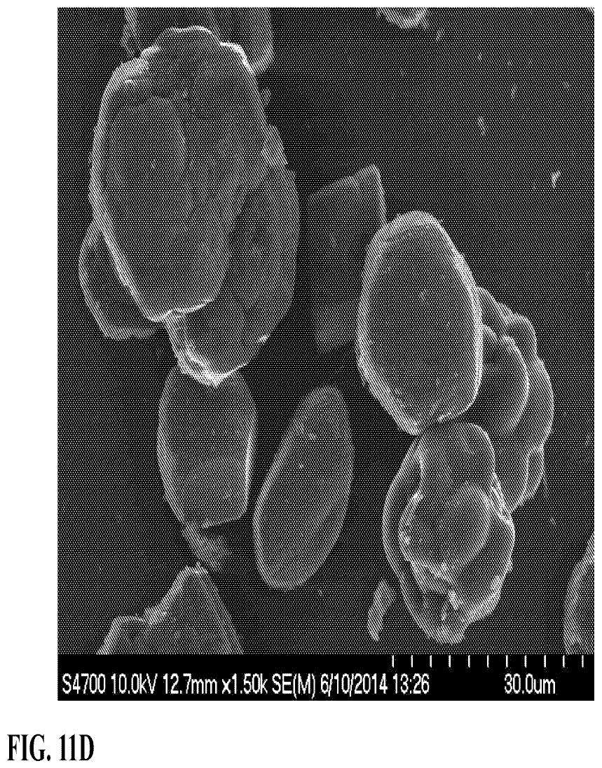

As noted, in the treatment industry PMA is a widely recognized crystal habit modifier to cubic calcium carbonate (calcite.) As can be observed in FIGS. 11A-11d, with PMA both polymer dosages “soften” the calcite and begin showing modifications features. Yet the presence of unmodified calcite is prominent in the 15 mg/l dosage (FIGS. 11A-11B) and is still observable at the 30 mg/l treatment level (FIGS. 11C-11D). At both dosages, the crystal modification achieved by PMA manifests as a “boulder” type shape.

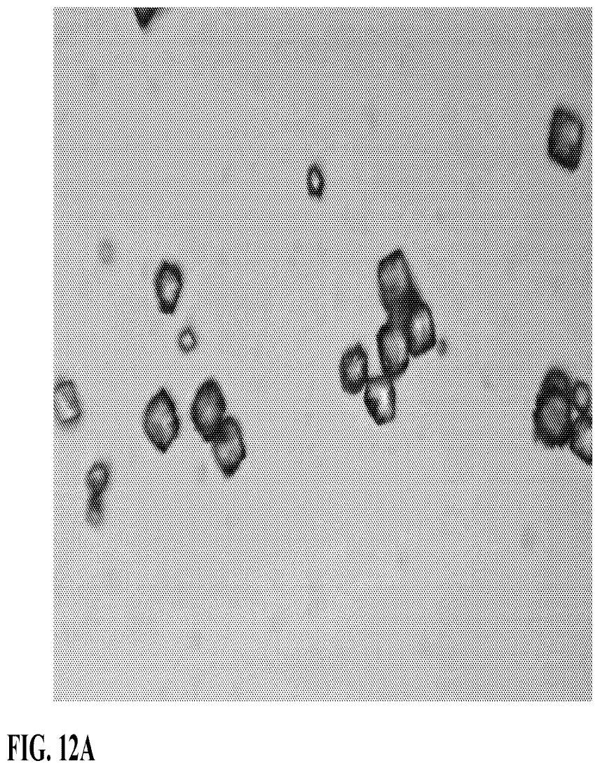

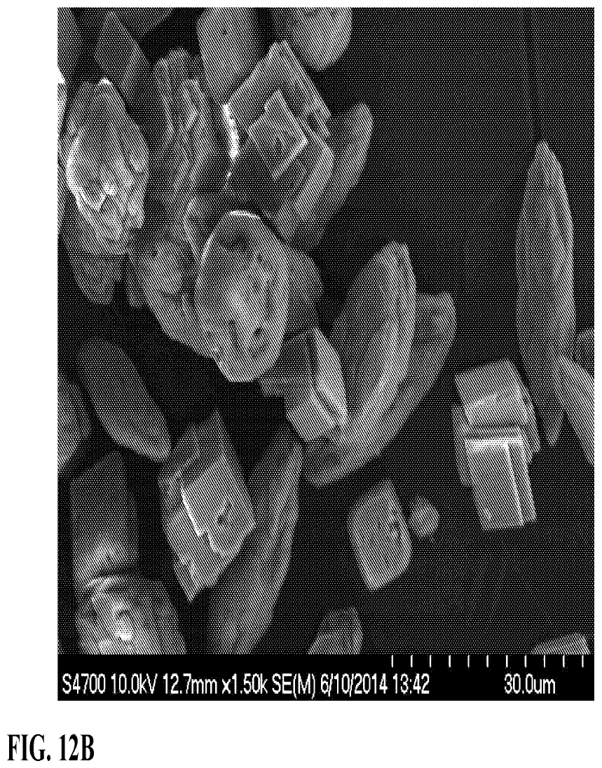

Multifunctional One Polymers (MOP) are relatively newer polymers which are designed for multiple-use purposes rather than specific performance as crystal habit modifiers. FIGS. 12A-12D show that MOP does not demonstrate the same level of crystal modification as compared to PMA in FIGS. 11A-11D. At both the 15 mg/l and 30 mg/l dosages, the MOP-treated samples retain much of their original, untreated cubic form. A potential explanation for this could be the polymer architecture and design. Typical MOP materials are 2,000-3,000 Mw and contain sulfonated monomers. These design features may limit the interaction of the polymer with forming calcite crystalloids and thus reduce the overall level of observed crystal habit modification.

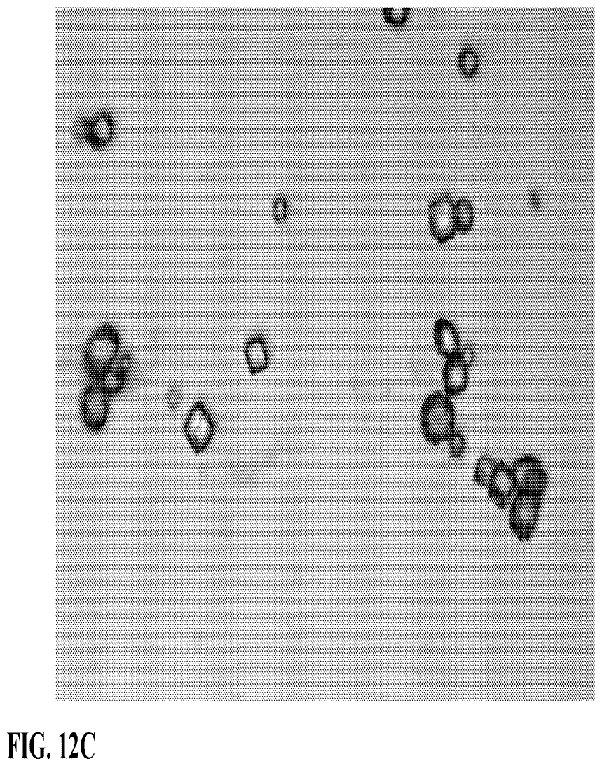

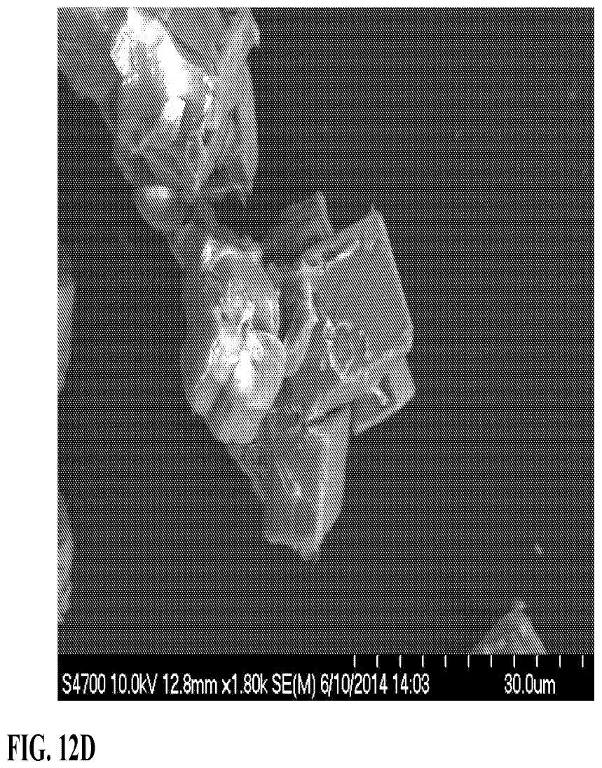

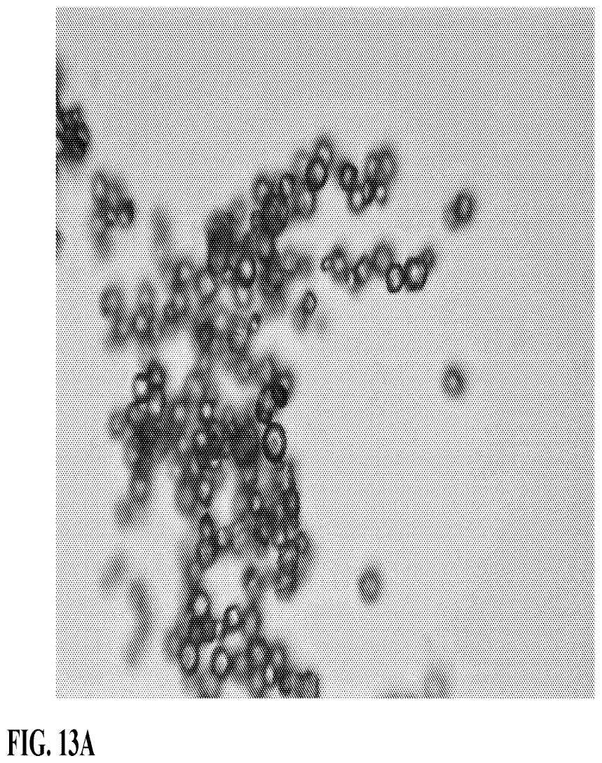

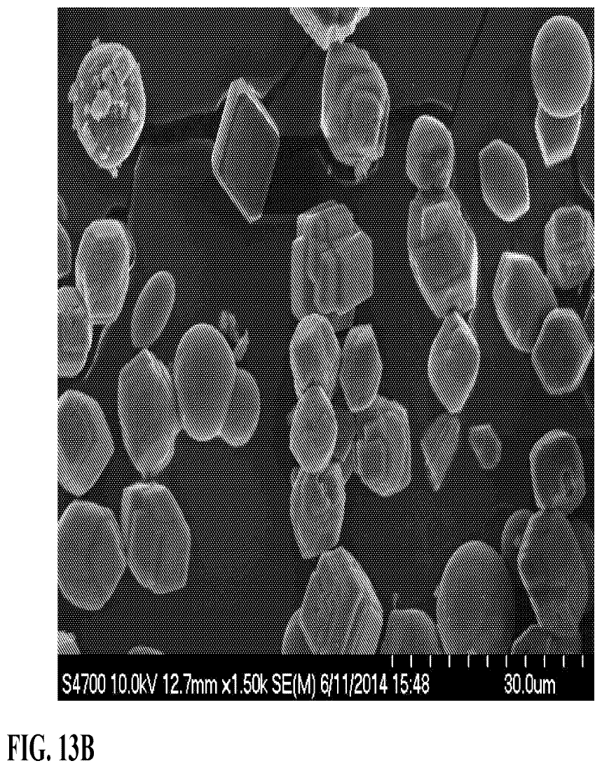

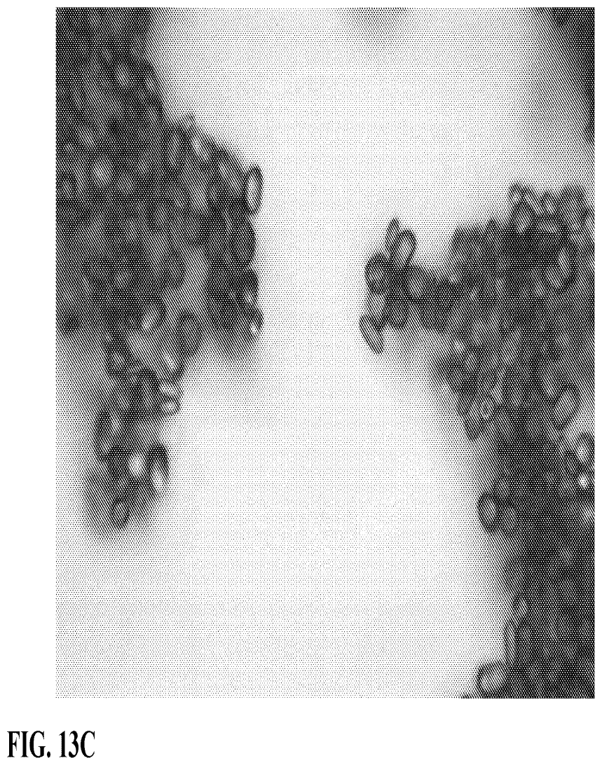

As represented in FIGS. 13A-13D, the degree, type, and quality of crystal distortion observed with an enhanced copolymer in accordance with the invention were unusual, unexpected, and unmatched by either the PMA or MOP polymers. Distinctive to such enhanced copolymers is the formation of spherical and rounded pill-shaped macro structures. Such structures are less likely to form strong adhesions onto metal surfaces, and require less mechanical energy to remove when they are deposited (see FIGS. 5A-5B). Remarkably, it can be observed that an enhanced copolymer even shows a greater degree of crystal distortion at lower treatment levels. FIGS. 13A-13B show an enhanced copolymer at a dosage of 15 mg/l, with resulting crystal distortion of over 50% of the potential cubic macro-lattices. Further, FIGS. 13C-13D show widespread crystal distortion of potential cubic macro-lattices at the 30 mg/l dosage.

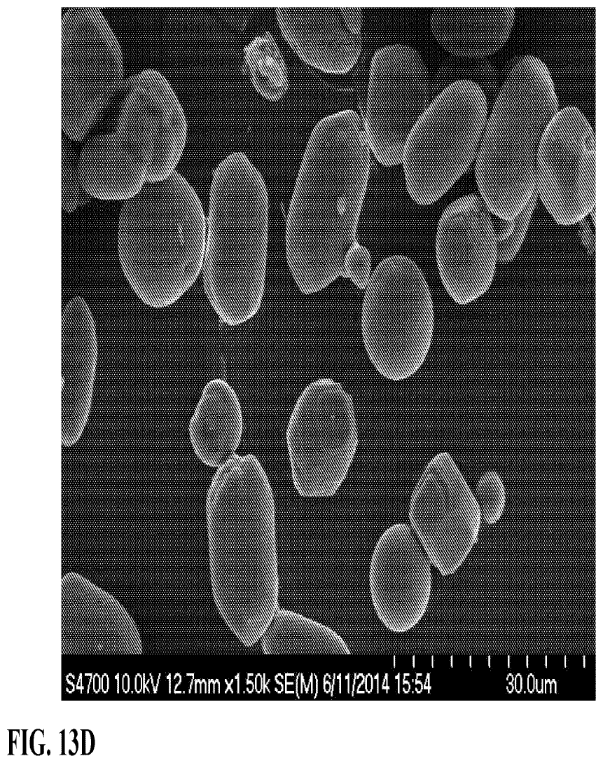

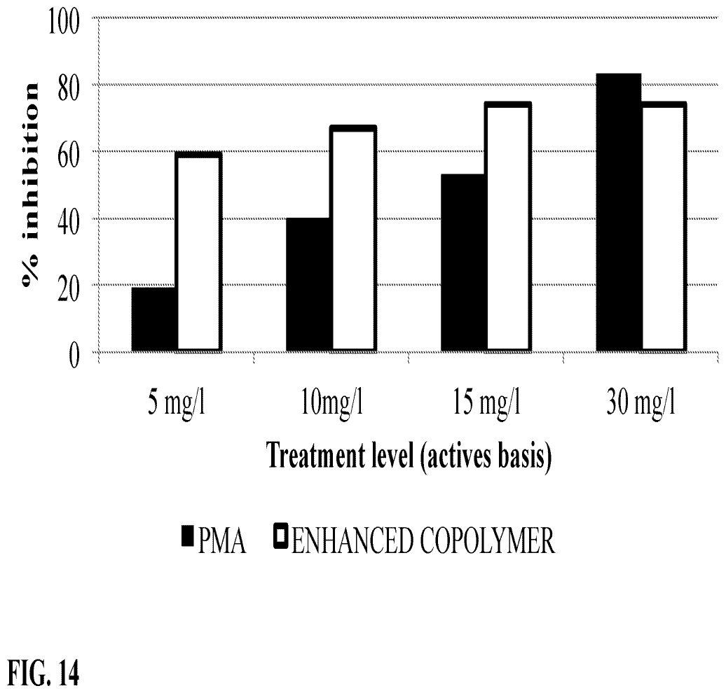

Targeted crystal habit modification performance, as discussed above, can also yield improved performance in related functional mechanisms of scale management. A comparison of PMA and an enhanced copolymer in accordance with the invention, as threshold inhibitors, was conducted using a “Severe Calcium” laboratory bottle testing method, with the results summarized in the chart depicted in FIG. 14. In this method, 50 ml of a solution containing 1200 mg/l Ca²⁺ was added to a French square bottle and treated with the indicated polymer dosage (as active). Then 50 ml of solution containing sodium carbonate (150 mg/l as CO₃²⁻), sodium bicarbonate (450 mg/l as CO₃²⁻), and a borate buffer (98 mg/l B₄O₇²⁻) was added to the calcium/polymer solution. All samples had a measured pH of ˜9.0 and were capped and placed in a water bath at 50° C. for 18 hours. The Langelier Saturation Index was calculated to be ˜3.0. In this evaluation, PMA and the enhanced copolymer were compared across increasing dosages of 5, 10, 15, and 30 mg/l on an active polymer basis. Within this severe calcium test, the enhanced copolymer demonstrates good stability in harsh conditions (high calcium, high alkalinity) and shows strong functionality as a threshold inhibitor, with better results than PMA at the lower treatment levels and slightly lower results at the 30 mg/l dosage. The inherent limitations of bottle testing for calcium carbonate inhibition and the small sampling of data suggest that more testing should be performed to evaluate boundaries of the enhanced copolymer's performance as a threshold inhibitor. As with PMA or any other inhibitor of this type, it may be recommended that such enhanced copolymers be formulated with PBTC (preferred) or HEDP to further enhance threshold inhibition functionality. A recommended ratio may be 3:1 copolymer to PBTC with a typical delivery 10 mg/l active polymer and 3 mg/l active PBTC as a starting point for many applications.

In an embodiment of the invention, an enhanced copolymer is prepared in-situ as a substantially maleic acid copolymer by polymerizing maleic acid monomer components. The maleic acid monomer components are transformed into monomeric repeating units within each polymer molecule. Preferably, this is aqueous polymerization, a process known in the art, which may provide various advantages such as being more economical than alternate methods of polymerization, yielding a polymer with lower aquatic toxicity, etc. An additional and previously under-appreciated advantage of aqueous polymerization is that it can provide a superior environment for beneficial in-situ copolymerization, such as producing improved copolymers exhibiting superior crystal habit modification properties. Contrary to common practice and understanding, rather than attempting to minimize decarboxylation during the polymerization process, there is preferably an effort to increase decarboxylation. This may be achieved, e.g., by changing various process parameters such as reaction temperature, the concentration of metal catalyst used, the concentration of hydrogen peroxide used, or adjusting other reaction additives. A result of increased decarboxylation is that, during the polymerization process, some of the maleic acid monomer components become non-carboxylated monomeric repeating units of the polymer being formed, resulting in an in-situ created copolymer rather than a substantially pure homopolymer. Preferably the process also gives rise to terminal hydroxyl groups in the copolymer.

Thus, the copolymer includes a quantity of non-functionalized groups which may, in application, aid in the adsorption of the polymer onto a crystal surface. An enhanced polymaleic acid copolymer prepared in such a manner may preferably include mono-carboxylic acids, non-ionic functional groups, and terminal hydroxyl groups in proportions to achieve the desired treatment functionalities. For example, such a copolymer may include at least approximately 10% (Mw) polymaleic acid and at least approximately 10% (Mw) of in-situ formed co-monomers, including at least 10% (Mw) decarboxylated maleic acid.

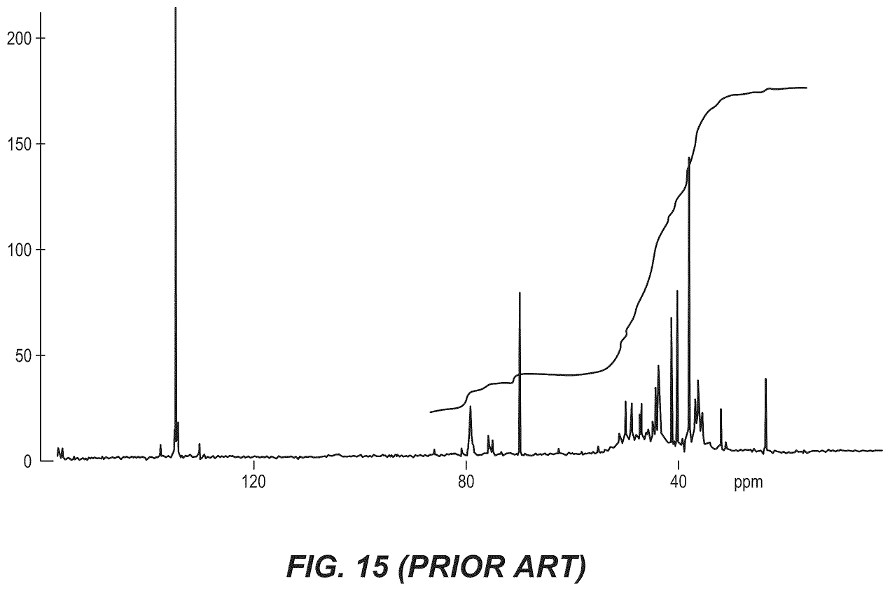

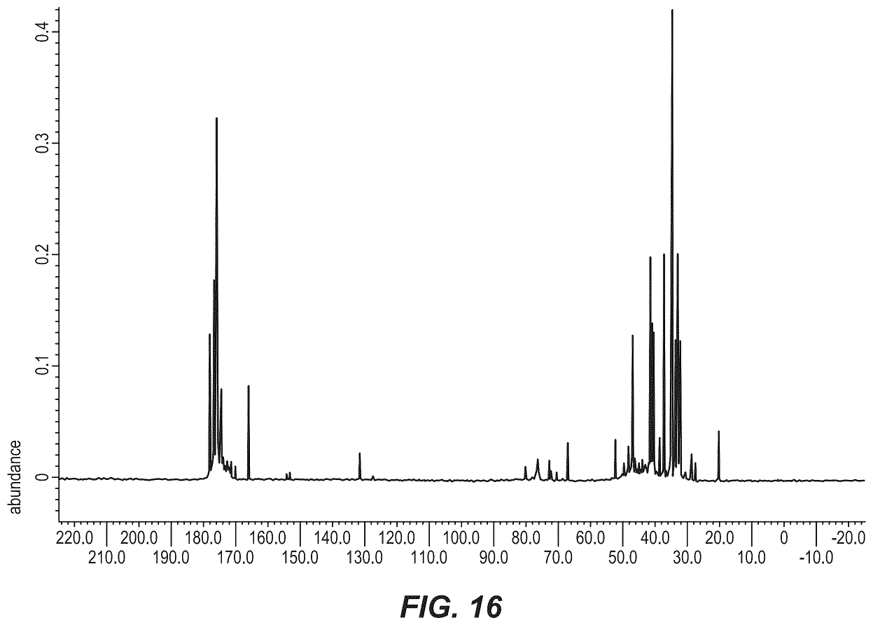

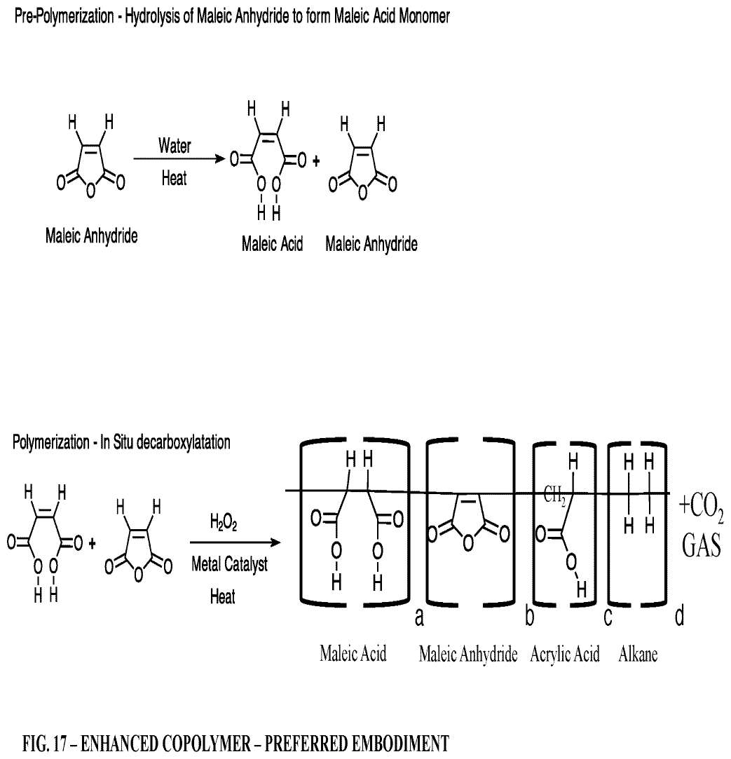

FIGS. 15 and 16 are nuclear magnetic resonance (NMR) spectrographs characterizing the chemical properties of two polymer additives. Comparing FIG. 15 (prior art) with FIG. 16 (enhanced copolymer) shows a significantly higher proportion of decarboxylated monomeric repeating units in the enhanced copolymer. In illustrative preferred embodiments of the enhanced copolymer described in FIG. 17, with molecular weight of the combined copolymer between 300 and 3,000 Daltons, copolymer constituent proportions are specified as follows:
Maleic Acid is present at over 50 molar %
Maleic Anhydride may be present at up to 5 molar %
Acrylic Acid is present at up to 50 molar %
a 2-carbon alkane group is present at up to 50 molar %

A copolymer prepared in accordance with the principles disclosed herein, or characterized by the attributes disclosed herein, as a further embodiment of the invention may then be applied to an aqueous system as a treatment additive to prevent or remediate mineral scaling. In application, the copolymer may, among other functionalities, adsorb onto crystalloid or crystal lattice structures, with a result of modifying the crystal habit of, e.g., an undesirable inorganic compound. Some examples of such compounds include calcium carbonate, calcium sulfate, barium sulfate, calcium oxalate, calcium phosphate, silica, or silicates.

Composition components (supplied or produced in-situ during polymerization) used in preparing an improved copolymer in accordance with embodiments of the invention may be selected and adjusted in ratios intended to optimize a single functional mechanism for scale control (preferably the mechanism of crystal habit modification), or to achieve a desired balance of multiple mechanisms. For example, ratios of carboxylates, sulfonates, and non-ionic compounds may be adjusted so that the ratio of non-ionic compounds is selected to optimize polymer adsorption on crystal surfaces, while the ratios of carboxylates and sulfonates are selected to retain adequate threshold inhibition, chelation, and sequestration properties of the copolymer additive.

Many modifications or expansions upon the invention and the various illustrative embodiments described in this application still fall within the spirit and scope of the invention and should be so considered.

As used herein the term, “random copolymer” refers to copolymers in which the two or more types of monomers are randomly distributed along the polymer chain.

As used herein the term, “alternating copolymers” refers to copolymers in which the monomers are arranged in an alternating fashion along the polymer chain.

As used herein the term, “block copolymers” refers to copolymers that have two or more homopolymer subunits linked together. Each block is a sequence of one type of monomer.

As used herein the term, “graft copolymers” refers to copolymers in which side-chains, which are constitutional or configurational different from those in the main chain block are connected to the main chain.

As used herein the term, “periodic copolymers” refers to copolymers that have a regular repeating pattern of monomers that is longer than an alternating pattern.

As used herein the term, “statistical copolymers” refers to a subtype of random copolymers in which the sequence distribution of monomers follows statistical rules.

As used herein the term, “gradient copolymers” refers to copolymers in which the composition gradually changes along the chain.

As used herein the term, “multiblock copolymers” refers to copolymers similar to block copolymers but that have more than two distinct blocks.

As used herein the term, “star copolymers” refers to copolymers in which multiple polymer chains (or arms) of varying composition extend from a central core.

As used herein the term, “diblock copolymers” refers to a subtype of block copolymers, consisting of two distinct blocks.

As used herein the term, “triblock copolymers” refers to a subtype of block copolymers, consisting of three distinct blocks.

### Copolymers

Various embodiments relate to copolymers. The copolymers may have any structure, and may include but are not limited to random copolymers, alternating copolymers, block copolymers, graft copolymers, periodic copolymers, statistical copolymers, gradient copolymers, multiblock copolymers, star copolymers, deblock copolymers, and triblock copolymers. The polymers may comprise any combination of vinyl monomers having a structure according to Formula 1.

According to various embodiments, the copolymers may also comprise one or more multifunctional monomers such as methylenebisacrylamide, diallyl phthalate, divinyl benzene, tetra allyl ammonium chloride, to facilitate branching, structuring, or crosslinking.

According to various embodiments, the copolymers may also comprise one or more covalent tag detectable fluorescent monomers such as
1H-Benz[de]isoquinoline-2(3H)-propanaminium, N-[2-hydroxy-3-(2-propen-1-yloxy) propyl]-6-methoxy-N,N-dimethyl-1,3-dioxo-, hydroxide;
1H-Benz[de]isoquinoline-2(3H)-propanaminium, N-[2-hydroxy-3-(2-propen-1-yloxy) propyl]-N,N-dimethyl-1,3-dioxo-, hydroxide; or
1H-Benz[de]isoquinoline-2(3H)-propanaminium, 6-methoxy-N, N-dimethyl-1,3-dioxo-N-2-propen-1-yl-, chloride.

Various embodiments relate to blends of various polymers comprising any combination of vinyl monomers having a structure according to Formula 1, blends of various copolymers comprising any combination of vinyl monomers having a structure according to Formula 1, as well as to blends of one or more polymers comprising any combination of vinyl monomers having a structure according to Formula 1 with one or more copolymers comprising any combination of vinyl monomers having a structure according to Formula 1.

The polymers, copolymers, and blends according to the various embodiments may be liquids or powders.

The polymers and copolymers may preferably comprise from about 10% to about 100%, or from about 20% to about 90%, or from about 30% to about 80%, or from about 40% to about 70%, or from 50% to about 60%, or at least about 50% by weight of a maleic acid monomer as shown hereinafter in Formula 2. The maleic acid monomer may be 5% decarboxylated to at least 50% decarboxylated.

Other monomers according to Formula 1 may also be decarboxylated. For example acrylic acid, itaconic acid, crotonic acid. The other monomer may be 5% decarboxylated to at least 50% decarboxylated.

The polymers and copolymers described herein may be prepared by conventional aqueous polymerisation for example with a peroxide such as hydrogen peroxide with a transition metal as a co-initiator or by solvent polymerisation, in, for example, xylene or other aromatic compounds, of maleic anhydride with subsequent extraction into water and hydrolysis to maleic acid decarboxylation can occur during polymerisation or can occur post polymerisation.

### Vinyl Monomers

Vinyl monomers are monomers that have a carbon-carbon double bond. The carbon-carbon double bond makes the monomer reactive and allows it to polymerize.

The vinyl monomers may have a structure according to Formula 1.

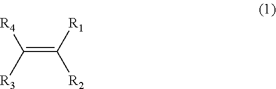

### Unsaturated Carboxylic Acids

As used herein, “unsaturated” hydrocarbons are hydrocarbons that have double or triple covalent bonds between adjacent carbon atoms. The configuration of an unsaturated carbons include straight chain, such as alkenes and alkynes, as well as branched chains and aromatic compounds.

Unsaturated carboxylic acids have a carbon-carbon double bond attached to a carboxyl group. This double bond makes them reactive and allows them to polymerize.

R₁, R₂, R₃, and R₄ may be independently selected from
H,
a carboxyl group, or the salt of a carboxy group
a phenyl group,
an pyridyl group,
an imidazolyl group,
a pyrrolidone group,
a linear or branched C₁-C₆ nitrile,
a linear or branched C₁-C₆ alkyl,
a linear or branched C₁-C₆ alkyloxy,
a substituent according to Formula S1,

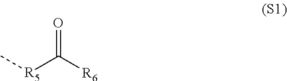

an ether substituent according to Formula S2,

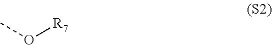

an ester substituent according to Formula S3,

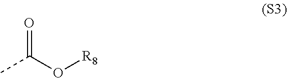

an amide substituent according to Formula S4,

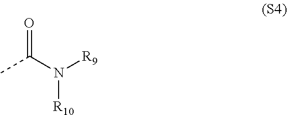

a phosphonate substituent according to Formula S5

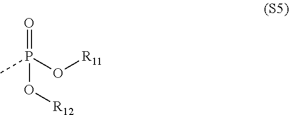

a sulfonic acid substituent according to Formula S6 or a salt thereof according to Formula

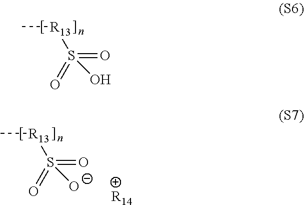

a quaternary ammonium substituent according to Formula S7

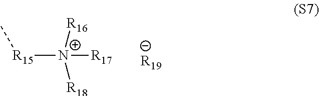

in which:
R₈ may be
O,
NH,
C₁-C₆ alkylene bridge,
C₁-C₆ oxyalkylene bridge,
R₆ may be
a linear or branched C₁-C₆ alkyl.
a linear or branched C₁-C₆ alkoxy,
OH
R₇ may be a linear or branched C₁-C₆ alkyl
R₈ may be
H,
a linear or branched C₁-C₆ alkyl,
R₉ may be
H,
a linear or branched C₁-C₆ alkyl,
R₁₀ may be
H,
a linear or branched C₁-C₆ alkyl,
R₁₁ may be
H,
a linear or branched C₁-C₆ alkyl,
R₁₂ may be
H,
a linear or branched C₁-C₆ alkyl,
R₁₃ may be
a linear or branched C₁-C₆ alkyl,
a linear or branched C₁-C₆ alkoxy,
a linear or branched C₁-C₆ hydroxy alkoxy,
a linear or branched C₁-C₆ alkyamide,
a linear or branched C₁-C₆ ester,
a C₃-C₆ cycloalkene bridge,
n may be 0 or 1,
R₁₄ may be a cation selected from
sodium (Na⁺),
potassium (K⁺),
ammonium (NH₄⁺),
monoethanolammonium, as shown in Formula C1

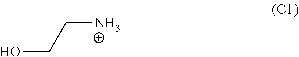

diethanolammonium, as shown in Formula C2

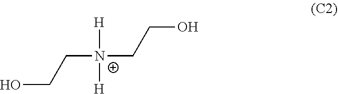

triethanolammonium, as shown in Formula C3

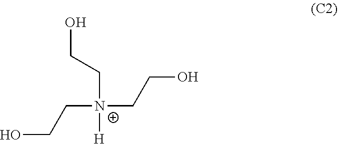

calcium (Ca²⁺),
magnesium (Mg²⁺),
aluminium (Al³⁺)
R₁₅ may be
a linear or branched C₁-C₆ alkyl,
a linear or branched C₁-C₆ alkyamide,
a linear or branched C₁-C₆ ester,
R₁₆, R₁₇, and R₁₈ may be independently selected from
H,
a linear or branched C₁-C₆ alkyl,
a linear or branched C₁-C₆ alkyne,
(C₁-C₆ alkyl)phenyl,
R₁₉ may be an anion selected from
chloride (Cl⁻),
bromide (Br⁻),
iodide (I⁻),
methyl sulfate, as shown in Formula A1

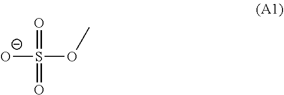

### SPECIFIC EXAMPLES

Although a variety of specific examples of useful comonomers will now be shown, it is to be appreciated that these examples are not intended to limit the scope of Formula 1. As shown in Formula 2, Formula 1 may represent maleic acid, in which R₁ is a carboxyl group, R₂ is H, R₃ is H, and R₄ is a carboxyl group.

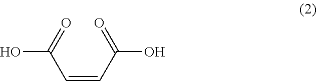

As shown in Formula 3, Formula 1 may represent acrylic acid, in which R₁ is a carboxyl group, R₂ is H, R₃ is H, and R₄ is H.

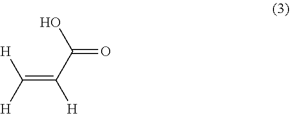

As shown in Formula 4, Formula 1 may represent methacrylic acid, in which R₁ is a carboxyl group, R₂ is a methyl group, R₃ is H, and R₄ is H.

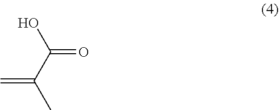

As shown in Formula 5, Formula 1 may represent itaconic acid, in which R₁ is a carboxyl group; R₂ is a substituent according to Formula S1, in which R₅ is a C₁ alkylene bridge and R₆ is OH; R₃ is H; and R₄ is H.

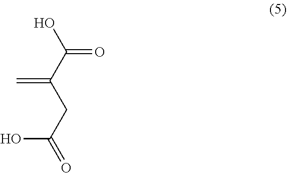

As shown in Formula 6, Formula 1 may represent fumaric acid, an isomer of maleic acid, in which R₁ is a carboxyl group, R₂ is H, R₃ is a carboxyl group, and R₄ is H.

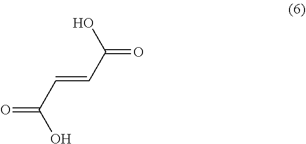

As shown in Formula 7, Formula 1 may represent crotonic acid, in which R₁ is a carboxyl group, R₂ is H, R₃ is a methyl group, and R₄ is H.

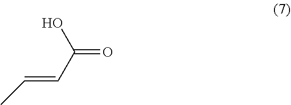

As shown in Formula 8, Formula 1 may represent methyl vinyl ether, in which R₁ is H; R₂ is H; R₃ is H; and R₄ is a substituent according to Formula S2, in which R₇ is a methyl group.

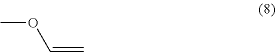

As shown in Formula 9, Formula 1 may represent vinyl acetate, in which R₁ is H; R₂ is a substituent according to Formula S1, in which R₅ is oxygen and R₆ is a methyl group; R₃ is H; and R₄ is H.

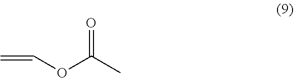

### Aromatic Monomers

As shown in Formula 10, Formula 1 may represent styrene, in which R₁ is a phenyl group, R₂ is H, R₃ is H, and R₄ is H.

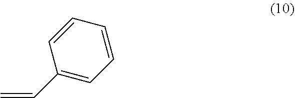

As shown in Formula 11, Formula 1 may represent vinyl pyridine, in which R₁ is a pyridyl group, R₂ is H, R₃ is H, and R₄ is H.

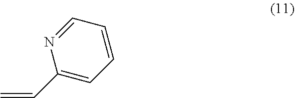

As shown in Formula 12, Formula 1 may represent 1-vinyl imidazole, in which R₁ is an imidazolyl group, R₂ is H, R₃ is H, and R₄ is H.

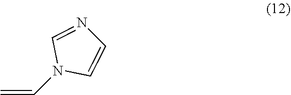

### Amine Monomers

As shown in Formula 13, Formula 1 may represent N vinyl pyrrolidone, in which R₁ is a pyrrolidonyl group, R₂ is H, R₃ is H, and R₄ is H.

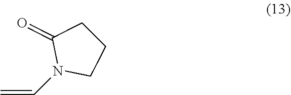

### Nitrile Monomers

As shown in Formula 14, Formula 1 may represent Acrylonitrile, in which R₁ is a linear C₁ nitrile, R₂ is H, R₃ is H, and R₄ is H.

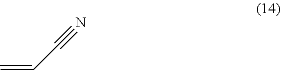

### Olefin Monomers

As shown in Formula 15, Formula 1 may represent ethylene, in which R₁ is H, R₂ is H, R₃ is H, and R₄ is H.

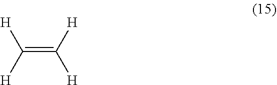

As shown in Formula 16, Formula 1 may represent isobutylene, in which R₁ is methyl, R₂, is methyl, R₃ is H, and R₄ is H

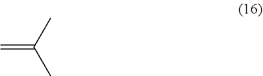

As shown in Formulas 17 and 18, Formula 1 may represent diisobutylene. As shown in Formulas 17 and 18, diisobutylene may represent 2,4,4-Trimethylpentene-2, in which R₁ is methyl, R₂ is methyl, R₃ is H, and R₄ is a branched C₄ alkyl

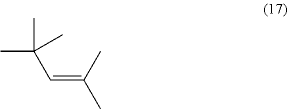

As shown in Formulas 17 and 18, diisobutylene may represent 2,4,4-Trimethylpentene-1, in which R₁ is H, R₂ is H, R₃ is methyl, and R₄ is a branched C₅ alkyl

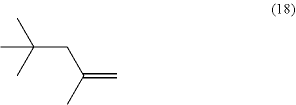

### Amide Monomers

As shown in Formula 19, Formula 1 may represent N-vinyl formamide, in which R₁ is a substituent according to Formula S1, in which R₅ is NH and R₅ is H; R₂ is H; R₃ is H; and R₄ is H.

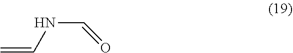

### Phosphonate Monomers

As shown in Formula 20, Formula 1 may represent vinyl phosphonic acid, in which R₁ is a phosphonate substituent according to Formula S5, in which R₁₁ is H and R₁₂ is H.

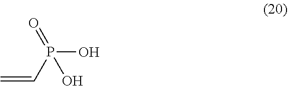

### Acrylate And Methacrylate Monomers

As shown in Formula 21, Formula 1 may represent methyl acrylate, in which R₁ is an ester substituent according to Formula S3, in which R₈ is methyl; R₂ is H; R₃ is H; and R₄ is H.

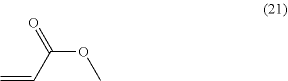

As shown in Formula 22, Formula 1 may represent ethyl acrylate, in which R₁ is an ester substituent according to Formula S3, in which R₈ is ethyl; R₂ is H; R₃ is H; and R₄ is H.

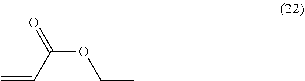

As shown in Formula 23, Formula 1 may represent methyl methacrylate, in which R₁ is an ester substituent according to Formula S3, in which R₈ is methyl; R₂ is methyl; R₃ is H; and R₄ is

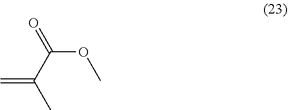

As shown in Formula 24, Formula 1 may represent ethyl methacrylate, in which R₁ is an ester substituent according to Formula S3, in which R₈ is ethyl; R₂ is methyl; R₃ is H; and R₄ is H.

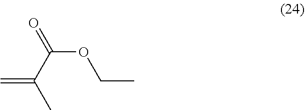

Additionally, Ethoxylated-aliphatic/aromatic hydrocarbon methacrylates such as Sipomer BEM and Sipomer SEM would react similarly and be useful in such copolymerizations.

### Acrylamide Monomers

As shown in Formula 25, Formula 1 may represent N-isopropyl acrylamide, in which R₁ is an amide substituent according to Formula S4, in which R₉ is a branched C₃ alkyl and R₁₀ is H; R₂ is H; R₃ is H; and R₄ is H.

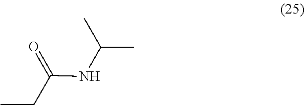

As shown in Formula 26, Formula 1 may represent acrylamide, in which R₁ is an amide substituent according to Formula S4, in which R₉ is H and R₁₀ is H; R₂ is H; R₃ is H; and R₄ is H.

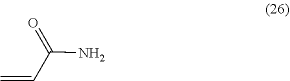

As shown in Formula 27, Formula 1 may represent t-butyl acrylamide, in which R₁ is an amide substituent according to Formula S4, in which R₉ is a branched C₄ alkyl and R₁₀ is H; R₂ is H; R₃ is H; and R₄ is H.

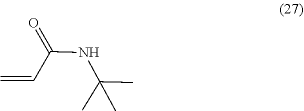

As shown in Formula 28, Formula 1 may represent N-methylacrylamide, in which R₁ is an amide substituent according to Formula S4, in which R₉ is methyl and R₁₀ is H; R₂ is H; R₃ is H; and R₄ is H.

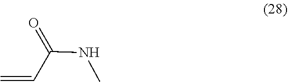

As shown in Formula 29, Formula 1 may represent N, N-dimethylacrylamide, in which R₁ is an amide substituent according to Formula S4, in which R₉ is methyl and R₁₀ is methyl; R₂ is H; R₃ is H; and R₄ is H.

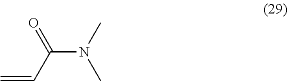

As shown in Formula 30, Formula 1 may represent methacrylamide, in which R₁ is an amide substituent according to Formula S4, in which R₉ is H and R₁₀ is H; R₂ is methyl; R₃ is H; and R₄ is H.

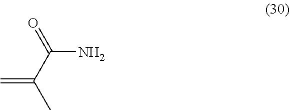

### Sulfonated Monomers

As shown in Formula 31, Formula 1 may represent allyl sulfonic acid or a salt thereof, like sodium allyl sulphonate, in which R₁ is a salt according to Formula S7, in which R₁₃ is C₁ alkyl and R₁₄ is Na⁺; R₂ is H; R₃ is H; and R₄ is H.

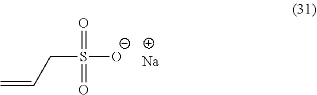

As shown in Formula 32, Formula 1 may represent methallyl sulfonic acid or a salt thereof, like sodium methallyl sulphonate, in which R₁ is a salt according to Formula S7, in which R₁₃ is C₁ alkyl and R₁₄ is Na⁺; R₂ is methyl; R₃ is H; and R₄ is H.

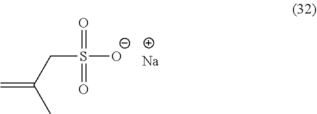

As shown in Formula 33, Formula 1 may represent 3-allyloxy-2-hydroxypropane sulfonic acid or a salt thereof, like sodium allyloxy-2-hydroxypropane sulphonate, in which R₁ is a salt according to Formula S7, in which R₁₃ is C₄ hydroxy alkoxy and R₁₄ is Na⁺; R₂ is H; R₃ is H; and R₄ is H.

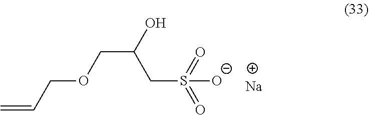

As shown in Formula 34, Formula 1 may represent 2-Acrylamido-2-methylpropane sulfonic acid or a salt thereof, like sodium 2-acrylamido-2-methylpropane sulphonate, in which R₁ is a salt according to Formula S7, in which R₁₃ is C₅ branched alkylamide and R₁₄ is Na⁺; R₂ is H; R₃ is H; and R₄ is H.

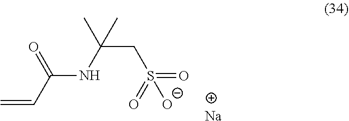

As shown in Formula 35, Formula 1 may represent vinyl sulfonic acid or a salt thereof, like sodium vinyl sulphonate, in which, in which R₁ is a salt according to Formula S7, in which n is 0 and R₁₄ is Na⁺; R₂ is methyl; R₃ is H; and R₄ is H.

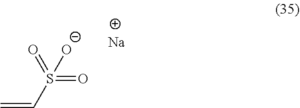

As shown in Formula 36, Formula 1 may represent vinylbenzene sulfonic acid or a salt thereof, like sodium vinylbenzene sulphonate, in which R₁ is a salt according to Formula S7, in which R₁₃ is a C₆ cycloalkene bridge and R₁₄ is Na⁺; R₂ is methyl; R₃ is H; and R₄ is H.

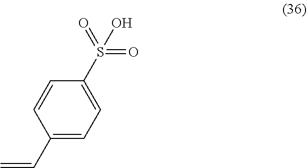

As shown in Formula 37, Formula 1 may represent 2-sulphoethyl methacrylate, like sodium 2-sulphoethyl methacrylate, in which R₁ is a salt according to Formula S7, in which R₁₃ is linear C₃ ester and R₁₄ is Na⁺; R₂ is methyl; R₃ is H; and R₄ is H.

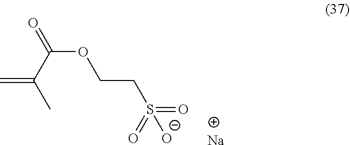

### Quaternary Ammonium Monomers

As shown in Formula 41, Formula 1 may represent diallyl dimethyl ammonium chloride, in which R₁ is a quaternary ammonium substituent according to Formula S7, in which R₁₅ is a C₁ alkyl, R₁₆ is a C₃ alkyne, R₁₇ is methyl, R₁₈ is methyl, and R₁₉ is a chloride anion; R₂ is H; R₃ is H; and R₄ is H.

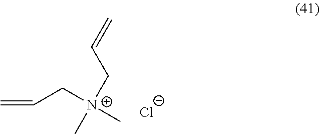

As shown in Formula 42, Formula 1 may represent methacrylamido propane trimethyl ammonium chloride, in which R₁ is a quaternary ammonium substituent according to Formula S7, in which R₁₅ is a C₄ alkylamide, R₁₆ is a methyl, R₁₇ is methyl, R₁₈ is methyl, and R₁₉ is a chloride anion; R₂ is methyl; R₃ is H; and R₄ is H.

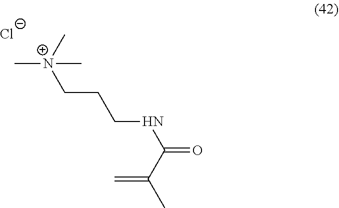

As shown in Formula 43, Formula 1 may represent acrylamido propane trimethyl ammonium chloride, in which R₁ is a quaternary ammonium substituent according to Formula S7, in which R₁₅ is a C₄ alkylamide, R₁₆ is a methyl, R₁₇ is methyl, R₁₈ is methyl, and R₁₉ is a chloride anion; R₂ is H; R₃ is H; and R₄ is H.

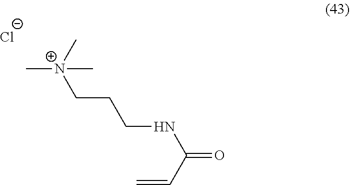

As shown in Formula 44, Formula 1 may represent a trimethyl amino ethyl acrylate chloride, in which R₁ is a quaternary ammonium substituent according to Formula S7, in which R₁₅ is a C₃ ester, R₁₆ is a methyl, R₁₇ is methyl, R₁₈ is methyl, and R₁₉ is a chloride anion; R₂ is H; R₃ is H; and R₄ is H.

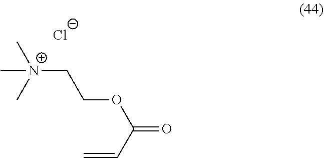

As shown in Formula 45, Formula 1 may represent a trimethyl amino ethyl methacrylate chloride, in which R₁ is a quaternary ammonium substituent according to Formula S7, in which R₁₅ is a C₃ ester, R₁₆ is a methyl, R₁₇ is methyl, R₁₈ is methyl, and R₁₉ is a chloride anion; R₂ is methyl; R₃ is H; and R₄ is H.

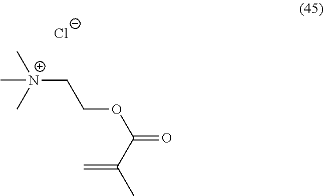

As shown in Formula 46, Formula 1 may represent a Dimethyl aminoethyl acrylate benzyl chloride, in which R₁ is a quaternary ammonium substituent according to Formula S7, in which R₁₅ is a C₃ ester, R₁₆ is a benzyl, R₁₇ is methyl, R₁₈ is methyl, and R₁₉ is a chloride anion; R₂ is H; R₃ is H; and R₄ is H.

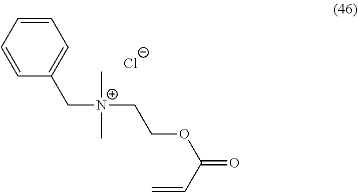 [SMILES: C=CC(=O)OCC[N+](C)(C)Cc1ccccc1 ; [Cl-]]

As shown in Formula 47, Formula 1 may represent a dimethyl aminoethyl methacrylate benzyl chloride, in which R₁ is a quaternary ammonium substituent according to Formula S7, in which R₁₅ is a C₃ ester, R₁₆ is a benzyl, R₁₇ is methyl, R₁₈ is methyl, and R₁₉ is a chloride anion; R₂ is methyl; R₃ is H; and R₄ is H.

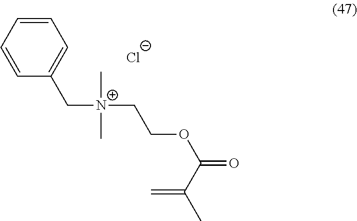 [SMILES: C=C(C)C(=O)OCC[N+](C)(C)Cc1ccccc1 ; [Cl-]]

As shown in Formula 44, Formula 1 may represent a trimethyl amino ethyl acrylate iodide, in which R₁ is a quaternary ammonium substituent according to Formula S7, in which R₁₅ is a C₃ ester, R₁₆ is a methyl, R₁₇ is methyl, R₁₈ is methyl, and R₁₉ is a chloride anion; R₂ is H; R₃ is H; and R₄ is H.

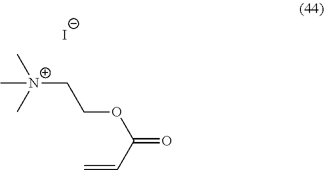

As shown in Formula 45, Formula 1 may represent a trimethyl aminoethyl methacrylate iodide, in which R₁ is a quaternary ammonium substituent according to Formula S7, in which R₁₅ is a C₃ ester, R₁₆ is a methyl, R₁₇ is methyl, R₁₈ is methyl, and R₁₉ is a chloride anion; R₂ is methyl; R₃ is H; and R₄ is H.

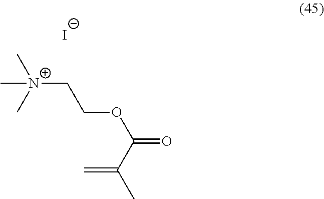

It is to be appreciated that physical blend comprising one or more polymers according to any of the embodiments described herein in the form of a liquid or in the form of a powder are also within the scope of the present disclosure.

It is also to be appreciated that the present disclosure contemplates preparation of the polymers according to any of the various embodiments by aqueous polymerization (as maleic acid) or by solvent polymerization of maleic anhydride with extraction into water and hydrolysis to maleic acid.

### EXAMPLES

The following examples are put forth to provide those of ordinary skill in the art with a complete disclosure and description of how to perform the methods, how to make, and how to use the compositions and compounds disclosed and claimed herein. Efforts have been made to ensure accuracy with respect to numbers (e.g., amounts, temperature, etc.), but some errors and deviations should be accounted for. The purpose of the following examples is not to limit the scope of the various embodiments, but merely to provide examples illustrating specific embodiments.

### Example 1

Polymerization example 1 is useful as a preparation means of a Maleic acid/acrylic acid copolymer with a 70/30 w/w ratio where the carboxylated copolymer shown contains greater than 5 molar % decarboxylation of maleic monomer. In the reaction, 170 g maleic anhydride was added to 145 g deionised water (201.2 g maleic acid) and the resulting solution added a five necked round bottom glass flask equipped with a stirrer, thermocouple two feed points for addition and a water cooled glass condenser. 5.5 g of a 1% ferrous ammonium sulphate aqueous solution was then added. The contents of the flask were heated to reflux temperature and 108 g 80% acrylic acid added to the reaction flask over 4 hours, separately 144 g of 30% hydrogen peroxide was added over the same period. Once the feeds were complete a further 14 g of 35% hydrogen peroxide and 0.55 g of 1% ferrous ammonium sulphate aqueous solution was added as separate aliquots and the flask contents were then left for an additional two hours at the reflux temperature and then cooled. The final product was a viscous dark brown solution and had a dry weight of 49%.

### Example 2

Polymerization example 2 is useful as a preparation means of Maleic acid/sodium allyl sulfonate copolymer with a 40/60 w/w ratio where the carboxylate/sulfonate copolymer shown results in greater than 5 molar % decarboxylation of maleic monomer. In the reaction, 184.5 g deionised water, 536.8 g 35% sodium allyl sulphonate and 107.6 g maleic anhydride were added to a resin pot equipped with a mechanical anchor stirrer, thermometer, two inlet points for liquid feeds and a water cooled condenser set to reflux mode. The contents were heated externally by an oil bath to a constant 60° C. and 1.6 g ascorbic acid and 2.3 g of a 1% ferrous ammonium sulphate solution added to the flask. A solution of 11.6 g sodium persulphate dissolved in 77.8 g deionised water was feed into the reactor over six hours. Simultaneously 85 g 35% hydrogen peroxide was added to the reactor over 6 hours. At the onset of the feeds the temperature was allowed to rise and maintained by external cooling at 90-95° C. After the feeds were complete 8.5 g 35% hydrogen peroxide and 0.23 g of 1% ferrous ammonium sulphate aqueous solution was added and the flask contents were then left for an additional two hours at temperature at 90-95° C. The condenser was moved to distillation mode and water was distilled off until the solids were 40.6% (dry weight 2 hours @ 110° C. in a fan oven). The product was a sightly viscous straw coloured liquid.

### Further Definitions and Cross-References

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of preparing in-situ a copolymer, comprising:
copolymerizing at least a portion of a plurality of maleic acid monomer components and one or more comonomers capable of reacting in a free-radical aqueous polymerizing system,
wherein some of such maleic acid monomer components are transformed into monomeric repeating units within each of a plurality of polymer molecules,
increasing decarboxylation during said polymerizing,
forming in-situ a copolymer molecule comprising at least one decarboxylated portion of said copolymer molecule, increasing an average frequency of non-carboxylated monomeric repeating units in said polymer molecules to at least approximately 5 molar %.

2. The method according to claim 1, wherein said polymerizing comprises aqueously polymerizing.

3. The method according to claim 2, wherein said increasing decarboxylation comprises adjusting one or more reaction parameters selected from the group of temperature, metal catalyst concentration, hydrogen peroxide concentration, polymerization reaction time, initial monomer concentration, concentration of intiator employed, free radical concentration, initiator half-life, initiator feed rate, monomer type, polymerization method employed, polymerization solvent type, polymerization solvent quantity and other reaction additives or conditions.

4. The method according to claim 2, wherein said copolymer molecule further comprises at least one terminal hydroxyl group.

5. The method according to claim 1, wherein the one or more comonomers are selected from the group consisting of acrylic acid, methacrylic acid, itaconic acid, fumaric acid, crotonic acid, and combinations thereof.

6. An aqueous treatment composition comprising a copolymer comprising:
at least 5 molar % decarboxylated maleic acid repeating units and one or more additional repeating units derived from comonomers capable of reacting in a free-radical aqueous polymerizing system.

7. A method comprising: applying the aqueous treatment composition comprising the copolymer of claim 6 to treat an aqueous system by modifying a crystal habit of at least one inorganic compound selected from the group consisting of calcium carbonate, calcium sulfate, barium sulfate, strontium sulfate, calcium fluoride, calcium oxalate, calcium phosphate, iron oxides, iron hydroxides, silica, and silicates.

8. A method according to claim 7, wherein the aqueous system is selected from the group consisting of industrial water systems, boilers, cooling towers, evaporators, digesters, membranes, thermal desalination systems, recreational water systems, swimming pools, spas, hot tubs, decorative fountains, potable water systems, reverse osmosis membranes, filtration systems, top-side oil systems, down-hole oil systems, top-side gas systems, down-hole gas systems, squeeze treatments, flood treatments, drilling systems, fracturing applications, mining systems, pulp- and paper systems, sugar evaporators, ethanol evaporators, household cleaning systems, laundry systems, and textile processing systems.

9. The method according to claim 1, further comprising copolymerizing in the presence of a fluorescent monomer.

10. The method according to claim 9, wherein the fluorescent monomer is selected from the group consisting of
1H-Benz[de]isoquinoline-2(3H)-propanaminium, N-[2-hydroxy-3-(2-propen-1-yloxy) propyl]-6-methoxy-N,N-dimethyl-1,3-dioxo-, hydroxide,
1H-Benz[de]isoquinoline-2(3H)-propanaminium, N-[2-hydroxy-3-(2-propen-1-yloxy)propyl]-N,N-dimethyl-1,3-dioxo-, hydroxide,
1H-Benz[de]isoquinoline-2(3H)-propanaminium, 6-methoxy-N, N-dimethyl-1,3-dioxo-N-2-propen-1-yl-, chloride,
and combinations thereof.

11. A method of preparing in-situ a substantially maleic acid copolymer, the method comprising: polymerizing a maleic acid monomer and a comonomer, and
increasing an average frequency of non-carboxylated monomeric repeating units in the substantially maleic acid copolymer to at least approximately 5 molar %,
wherein the comonomer has a structure according to Formula I 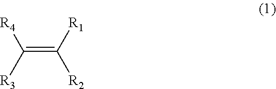
in which R₁, R₂, R₃, and R₄ are independently selected from
H,
a carboxyl group, or the salt of a carboxy group
a phenyl group,
an pyridyl group,
an imidazolyl group,
a pyrrolidone group,
a linear or branched C₁-C₆ nitrile,
a linear or branched C₁-C₆ alkyl,
a linear or branched C₁-C₆ alkyloxy,
a substituent according to Formula S1, 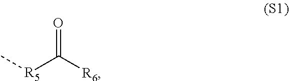
an ether substituent according to Formula S2, 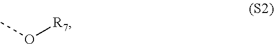
an ester substituent according to Formula S3, 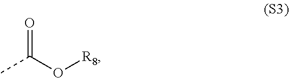
an amide substituent according to Formula S4, 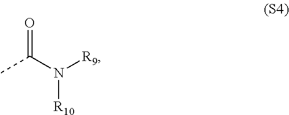
a phosphonate substituent according to Formula S5 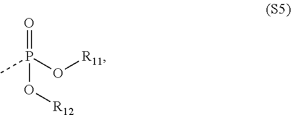
a sulfonic acid substituent according to Formula S6 or a salt thereof according to Formula S7 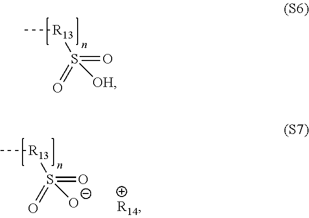
a quaternary ammonium substituent according to Formula S7 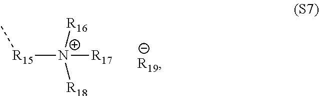
in which:
R₅ is selected from
O,
NH,
C₁-C₆ alkylene bridge,
C₁-C₆ oxyalkylene bridge,
R₆ is selected from
a linear or branched C₁-C₆ alkyl.
a linear or branched C₁-C₆ alkoxy,
OH
R₇ is selected from a linear or branched C₁-C₆ alkyl
R₈ is selected from
H,
a linear or branched C₁-C₆ alkyl,
R₉ is selected from
H,
a linear or branched C₁-C₆ alkyl,
R₁₀ is selected from
H,
a linear or branched C₁-C₆ alkyl,
R₁₁ is selected from
H,
a linear or branched C₁-C₆ alkyl,
R₁₂ is selected from
H,
a linear or branched C₁-C₆ alkyl,
R₁₃ is selected from
a linear or branched C₁-C₆ alkyl,
a linear or branched C₁-C₆ alkoxy,
a linear or branched C₁-C₆ hydroxy alkoxy,
a linear or branched C₁-C₆ alkyamide,
a linear or branched C₁-C₆ ester,
a C₃-C₆ cycloalkene bridge,
n may be 0 or 1,
R₁₄ is a cation selected from
sodium (Na⁺),
potassium (K⁺),
ammonium (NH₄⁺),
monoethanolammonium, as shown in Formula C1 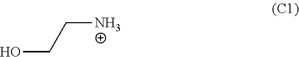
diethanolammonium, as shown in Formula C2 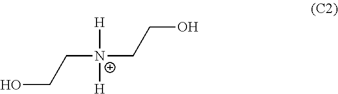
triethanolammonium, as shown in Formula C3 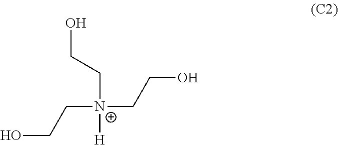
calcium (Ca²⁺),
magnesium (Mg²⁺),
aluminium (Al³⁺)
R₁₅ is selected from
a linear or branched C₁-C₆ alkyl,
a linear or branched C₁-C₆ alkyamide,
a linear or branched C₁-C₆ ester,
R₁₆, R₁₇, and R₁₈ is independently selected from
H,
a linear or branched C₁-C₆ alkyl,
a linear or branched C₁-C₆ alkyne,
(C₁-C₆ alkyl)phenyl,
R₁₉ is an anion selected from
chloride (Cl⁻),
bromide (Br⁻),
iodide (I⁻),
methyl sulfate, as shown in Formula A1 [chemical structure]
